(19) United States
(12) Patent Application Publication
(10) Pub. No.: US 2014/0148741 A1
(43) Pub. Date: May 29, 2014

(54) SYSTEMS AND METHODS OF COSMETO-COMPRESSION APPAREL

(71) Applicant: Michelle Moran, Sudbury, MA (US)

(72) Inventor: Michelle Moran, Sudbury, MA (US)

(21) Appl. No.: 13/983,965

(22) PCT Filed: Feb. 9, 2012
(86) PCT No.: PCT/US2012/024531

§ 371 Date: Aug. 23, 2013

Related U.S. Application Data
(60) Provisional application No. 61/441,457, filed on Feb. 10, 2011.
(60) Provisional application No. 61/441,526, filed on Feb. 10, 2011.

(51) Int. Cl. A61H 1/00

(52) U.S. Cl. CPC A61H 1/008
USPC 601/84; 8/137; 34/282

(57) ABSTRACT

Systems and methods described may include a garment configured to apply compressive force to the body of the wearer during wear and may receive, retain, and release a garment treatment to the wearer during wear. Garment treatments may be configured to create physiological response in the wearer through contact with the wearer's skin. A method described may include reducing the circumference of a body part during a time period, treating a cosmetocompression garment configured to cover at least a part of the body part with a slimming or other health treatment, putting on the treated cosmetocompression garment to cover at least a part of the body part, and wearing the treated cosmetocompression garment according to a schedule. A water soluble laundry packet or a dry sheet may be configured to deliver any combination of a detergent, fabric softener, antistatic substance and garment treatment during wash or drying cycle of laundry.

### CROSS-REFERENCE TO RELATED APPLICATIONS

The present application claims priority to U.S. Provisional Patent Application Ser. No. 61/441,457, filed on Feb. 10, 2011, entitled “Systems and Methods of Cosmeto-Compression Apparel” and to U.S. Provisional Patent Application Ser. No. 61/441,526, filed on Feb. 10, 2011, entitled “Systems and Methods of Laundry Treatment of Apparel”, both of which are incorporated by reference herein in their entirety.

### FIELD OF THE INVENTION

The present invention relates to apparel providing health benefits during wear. More particularly the present invention relates to garments providing compression and delivering health products during wear.

### BACKGROUND

Apparel and garments with associated health benefits have been known for centuries. Some garments are geared towards cosmetic or health treatments.

Cellulite is a major beauty concern for women. Some studies show that 85% of U.S. women suffer from cellulite, and that over 40% of women with cellulite are embarrassed by the condition and seek products to alleviate its appearance.

Compression garments have been used to enhance appearance of the wearer, from the advent of corsets and girdles. One contemporary example includes Spanx® garments for women. Compression garments are also well known for their post surgical recovery effects, for example after cosmetic surgery.

### SUMMARY OF THE INVENTION

Some garments use textiles that are treated with a cosmetic or health product to be released onto the wearer during use. For example, some cosmetotextiles use micro-encapsulation of a skin or health product, for time release or instant release upon wear. Another technology, known as the area of dermotextiles, uses micro-particles of a health product to be imparted to the wearer. Various treated garment technologies have been used in the past in an attempt to treat cellulite. Because compression garments increase circulation, they may help speed the healing process. Compression garments are also used to treat recurring or chronic health issues such as the symptoms of diabetes or lymphedema. One use is in the treatment of varicose veins.

Clothes cover a large part of the body for most of the day or night, presenting an ideal opportunity for the convenient transfer of cosmetics, pharmaceuticals, cosmetoceuticals, or other health or wellness treatments. Embodiments of the present inventions can use textiles that combine compressive characteristics with cosmetotextiles or dermotextiles in novel ways to yield salutary health effects for the wearer. Embodiments of the present invention include garments and apparel using the present, novel cosmetocompression technology. As used herein, “cosmetocompression” refers to garments that combine strategically-placed regions of various compression textiles with cosmetotextiles or dermotextiles in a novel way to provide more and different benefits than are possible using existing technologies.

In various exemplary embodiments, the combination of compression and cosmetotextile characteristics inherent in the inventive cosmetocompression garments can greatly enhance the benefits of the garments by maintaining the textile in contact with the skin. This contact may be used to ensure the uniform release of health preparations across the affected area, and can be used to take advantage of the skin's natural characteristics to trigger the release of the health preparations in a controlled or predictable way. Further, the compressive aspect of the cosmetocompression textile may also add resistance to the wearer's movements, which can contribute to the burning of calories and to the toning and exercise of the underlying musculature.

In various embodiments, a textile fabric may be treated to receive, retain, and release garment treatments such as firming, cosmeceutical, pharmaceutical, wellness or cosmetic preparations. In various embodiments garment treatments may be liquids, creams, or powders. Garment treatments may be applied through various delivery mechanisms, such as through liquid spray, an atomizer, nebulizer, aerosol, through steaming, soaking, infusing, or other delivery mechanisms as are known in the textile treatment arts. Some embodiments of the present cosmetocompression garments may be treated incident to laundering or cleaning the garment, for example during washing, drying, ironing, dry cleaning, or steaming. In various embodiments, the cosmetocompression textiles may be treated initially incident to manufacture, treated initially incident to dyeing, treated initially incident to garment construction, treated initially as a part of a post garment construction step, or treated initially by an end user. The effectiveness of the cosmetocompression textiles according the present invention may be periodically renewed as necessary by the user by reapplying or redelivering the garment treatment, for example to “recharge” it.

In various embodiments, garment treatments may be timed-release treatments. Other embodiments may use garment treatments configured to release their active ingredient(s) to the wearer substantially immediately upon donning or wearing the garment. Some embodiments of the present invention may employ microcapsule garment treatments. Other embodiments may employ microparticle or nanoparticle garment treatments not involving microcapsules.

Microcapsule and other garment treatments according to the present invention, such as microcapsule treatments, may offer a “dry” hand even immediately after treatment. Microcapsule treatments can be suspended in a delivery fluid, such as a gas or a liquid, that can dissipate or evaporate after treatment, leaving the microcapsules behind. The active ingredient of the garment treatment can be contained within the microcapsule, and become released only in response to mechanical, thermal, chemical, or moisture stimulus from the skin of the wearer, and only directly onto the skin of the wearer. This can result in the ability to wear the inventive garments under other clothes or as an outer layer without any perceptible “rub off” or “soak through” of the garment treatment onto other clothing or environmental surfaces.

In various embodiments the release or activity of the active element of the treatment preparation may be triggered during wear, such as by circumstances incident to wear. For example, in the case of an embodiment using microcapsules containing a health preparation, the health preparation my be released as the microcapsules are broken. Microcapsules may be broken due to friction, such as friction against the wearer's skin, pressure, temperature, such as the body heat of the wearer, or other circumstances as known in the microcapsule arts. Various examples of the microparticle, nanoparticle, or microcapsule embodiments of the present inventive cosmetocompression garments may release an active health preparation to the wearer based on binary activation, such as by the introduction of a second preparation. Other embodiments may release active ingredients in response to temperature, skin pH, such as triggered by the sweat or skin oils of the wearer, by moisture, such as ambient moisture or the moisture associated with the perspiration of the wearer, or another mechanism as is known in the microcapsule, microparticle, or nanoparticle arts.

In various embodiments, the garment treatment may be permanent or semi permanent. For example, one embodiment is provided with silver metal microparticles or nanoparticles, for example for antibacterial effect. Other embodiments can incorporate permanent or semi permanent dermabrasion regions. For example, some embodiments may incorporate an embedded region of a persistent abrasive such as a pumice or other abrasive as is known in the dermatological arts.

The capacity for the various embodiments of the present inventions to receive, retain, and release various cosmetic, wellness or pharmacological preparations may be a function of the textile fibers, or can be a result of post-manufacture processing, such as a permanent fiber surface treatment provided before or after the fibers are made into a textile, or during any coloring or dyeing process.

In various embodiments, garment treatments may be cosmetic in nature, such as self-tanning preparations, essential oils, moisturizers, glycolic acid, retinol, antioxidants, alpha hydroxyl acids, bleaches, lighteners, or other cosmetic skin treatments as are known in the dermatological arts. In various embodiments, garment treatments may be body slimming, toning, firming, or shaping treatments, for example calorie burning treatments, or metabolic enhancers. In various embodiments, garment treatments may be wellness treatments such as aromatherapies.

In various embodiments, garments treatments may have a pharmacological activity, such as provided by over the counter preparations and prescription pharmaceutical treatments. In various embodiments, the treatments may include topical or transdermal skin treatments, corticosteroids, rubefacients, anti-irritants, antihistamines, anti-allergy preparations, anti-inflammatories, anesthetics, and analgesics. Some embodiments of the present invention can be treated with pharmaceutical products to treat various skin conditions, for example to treat acne. For example, some embodiments can be treated with benzoyl peroxide or salicylic acid. Some embodiments can be treated with preparations for the treatment of acne scarring or other skin scarring, such as dermabrasion or lighteners.

Various embodiments of the present inventive cosmetocompression garments may treated with garment treatments to relive muscle aches and muscle soreness, for example from overexertion, strains, or post exercise or labor soreness. For example, some embodiments can release muscle-soothing rubefacients such as menthol or another topical analgesic. In some embodiments, the rate of release of the active ingredient of the garment treatment can be a function of the activity level of the wearer, such as by using microcapsules that break open in response to friction or pressure from the wearer's body.

Some embodiments of the present inventive cosmetocompression garments can use a performance enhancing garment treatment, such as an energy stimulant, metabolic stimulant, or a nervous or circulatory stimulant, for example to boost performance during a sporting event or competition. Exemplary embodiments include base layer core garments such as resistance tee or shorts treated with herbal or synthetic metabolic stimulants, such as a thermogenic formula.

Various embodiments of garments according to the present invention may incorporate compression textiles for resistance. In some embodiments, the compression may be oriented in one or more distinct directions, or may be in all directions. In various embodiments, resistance regions in a garment may be used to create lift and support. For example, in various embodiments, textiles having a compression or stretch characteristic may be used such as nylon Spandex. Various embodiments of the present invention may use panels joined together. Joints between panels may be created, in various embodiments, through thermal fusing, sewn seams, or other joining provisions as are known in the textile arts. In some embodiments, the garments may be seamless.

Embodiments of the present inventive garments can be constructed of any synthetic fabric capable of being imparted with a compression characteristic, such as nylon, polyester, acrylic, polyolefin, rayon, acetate, or another synthetic fiber fabric. Other embodiments can be constructed from natural fibers, or a natural/synthetic blend using a natural fiber, such as wool, cotton, linen, flax, silk, jute, hemp, sisal, burlap, or any other natural fiber fabric capable of being incorporated into a textile imparted with a compression characteristic. Resistance regions may also be provided by the use of resistance bands incorporated into a base textile garment. Resistance bands can be used to create specific, directional resistance, and can be used to create regions and directions of relatively high resistance. Embodiments of the present invention may be created using woven or knit textiles, or other non-directional or directional stretch weaves and knits as are known in the textile arts.

In various embodiments of the present invention, textile fabrics having different levels of compression may be used to create “zones” of varying compression in the garment, for example in order to provide a particular level of compressive force to an area as appropriate or indicated. In various embodiments, different panels may be provided with seams located so as to reduce wear and tear on the garment, irritation to the wearer, or both. Some embodiments of the present inventive cosmetocompression garments may incorporate regions or panels having no stretch characteristics.

Garments according to the present invention can be men's garments, women's garments, unisex, and children's clothing. One embodiment of the present invention is configured for use by overweight and obese children. Garments according to the present invention can be professional wear, daytime wear, evening wear, formal wear, undergarments, athletic garments, sleeping garments, or any other type of clothing. For example, tank tops, camisoles, blouses, Capri pants, tights, shorts, tummy shorts, hosiery, and skorts. Garments according to the present invention can be worn alone or can be worn under other, conventional clothing.

Existing cosmetotextile, cosmetoceutical, and dermotextiles garments are available in several configurations. In some examples, the cosmetotextile properties must be periodically “recharged” through the application of a garment treatment. In other examples, recharging the garment is not possible; the garments are treated once during production, and their efficacy thereafter diminishes with wear and laundering, until they finally become “exhausted” after 20-30 washings. Such systems therefore have the disadvantage of only lasting for a short time, after which they are only usable as regular clothes with no associated cosmetic effect.

Other examples of existing cosmetotextile or dermotextile garments are periodically rechargeable by the user, such as by liquid spray application. Such systems require the user to remove the garment from the wash while still damp, turn it inside out, and then spray the interior of the wet garment with a spray bottle, making sure not to apply too much or too little in any particular spot. Such systems have the disadvantage of being very inconvenient for the user, and requiring special interruption of the user's normal laundry practices.

Also known are various delivery means for laundry products, such as detergents, fabric softeners, and anti-static substances. For example, laundry detergent is typically delivered in the form of a liquid or powder to the water of a wash load in a washing machine or for hand washing. Other detergent delivery systems include molded, soluble packets. Fabric softeners are generally known to be delivered in the form of a liquid to the wash cycle, or in the form of a sheet in the dry cycle. Antistatic substances are generally delivered according to the same delivery mechanisms.

In various embodiments of the present invention, a textile fabric may be treated to receive, retain, and release garment treatments such as firming, cosmeceutical, pharmaceutical, wellness or cosmetic preparations (a “garment treatment”). Some embodiments of the present invention include garment care systems for use with a conventional clothes washer and dryer. Embodiments of the present garment treatment systems can have activity during the wash, rinse, and/or dry cycles of a conventional laundry process, or can be used as a part of a dry cleaning process.

In some embodiments of the present garment treatment systems and methods, delivery systems for garment treatments can include liquids or powders to add to a laundry cycle, for example to a wash cycle in a conventional mechanical washing machine. Other embodiments include dryer sheet delivery systems. Some embodiments include water soluble packets or capsules that can be added to the washing cycle to deliver garment treatments alone or along with detergent, fabric softener, and/or antistatic treatments. Another embodiment is a washer/dryer sheet that is infused with detergent and/or garment treatment and fabric softener for the wash cycle, and is then transferred with the wet laundry to the dryer for the dry cycle, where it has an antistatic activity. A further embodiment is a fibrous, water permeable pouch containing a powder, for use in both the wash cycle as well as the dry cycle.

Using the laundry process as a delivery mechanism for garment treatments can result in a uniform application of the treatment throughout the garment. Garments treated in accordance with the present systems and methods can achieve healthful effects through the uniform release of health preparations across an affected area, such as an area of cellulite. Garment treatments delivered according to the present invention can take advantage of the skin's natural characteristics to trigger the release of the health preparations in a controlled or predictable way.

In one aspect, the present disclosure relates to a health garment system, comprising a garment for wearing in contact with the body of a wearer. The garment may comprise a plurality of zones comprising a stretching textile material, each zone connected to at least one other zone of the garment, each zone ergonomically placed to apply compression against the wearer to provide a health benefit. At least one zone of the garment may apply a compression force that is different from a compression force of another zone of the garment. A first zone of the plurality of zones may compress in a first direction and a second zone of the plurality of zones may compress in a second direction. The system may include a garment treatment which may include a garment preparation for enhancing the health benefit upon contact of the preparation with the body of the wearer. At least one zone of the garment may be configured to receive the garment treatment that includes the garment preparation.

In some embodiments, the health benefit comprises slimming. In some embodiments, the health benefit comprises reduction of cellulite. In further embodiments, the health benefit comprises improving muscle tone. In yet more embodiments, the health benefit comprises improvement of a skin condition. In some embodiments, the health benefit comprises improved energy for the wearer. In certain embodiments, the health benefit comprises relieving muscle pain.

The garment preparation may comprise a microparticle or a nanoparticle. The garment preparation may be configured to be applied by the wearer. The garment preparation may include any one of, or a combination of, a liquid, a cream or a powder. In some embodiments, the garment preparation is configured to be applied via any one of, or a combination of: a liquid spray, an atomizer, a nebulizer, an aerosol, steaming, soaking or infusing. In further embodiments, the garment preparation comprises any one of, or a combination of: a topical treatment for skin, transdermal skin treatment, a corticosteroid, a rubefacient, an anti-irritant, an antihistamine, an anti-allergy treatment, an anti-inflammatory treatment, an anesthetic or an analgesic. In some embodiments, the garment preparation comprises a microcapsule. In further embodiments, the garment preparation is released in response to mechanical, thermal, or chemical stimulus. In yet more embodiments, a third zone of the plurality of zones, the third zone comprising a material applying a non-directional compression force against the body of the wearer.

In some aspects, the present disclosure relates to a health method that includes a step of providing a garment for wear in contact with the body of a wearer. The garment may comprise a plurality of zones ergonomically disposed on the garment to provide a health benefit, each zone connected to at least one other zone and a first zone of the plurality of zones exerting a first compressive force on the body of the wearer when the garment is worn. The first compressive force may be different from a second compressive force exerted by a second zone. The first compressive force may be oriented along a first force direction, the first force direction different from a second force direction associated with the second compressive force. The method may further include the step of providing a garment preparation for treatment of the garment. The garment preparation may enhance the health benefit upon contact of the garment preparation with the of the wearer during wear of the garment.

In some embodiments, the method includes steps such as providing a garment preparation comprises providing a garment preparation configured to enhance a body slimming health benefit. In some embodiments, providing a garment preparation comprises providing a garment preparation configured to enhance a visible cellulite reduction health benefit. In further embodiments, providing a garment preparation comprises providing a garment preparation configured to enhance a muscle tone improvement health benefit. In some embodiments, providing a garment preparation comprises providing a garment preparation configured to enhance a skin condition health benefit. In further embodiments, providing a garment preparation comprises providing a garment preparation configured to enhance an energy increase health benefit. In some embodiments, providing a garment preparation comprises providing a garment preparation configured to enhance a visible cellulite reduction health benefit. In certain embodiments, providing a garment preparation comprises providing a garment preparation comprising microparticles. In further embodiments, providing a garment preparation comprises providing a garment preparation comprising one of: a liquid, a cream or a powder. In still further embodiments, providing a garment preparation for treatment of the garment comprises providing a garment preparation for treatment of the garment via one of: a liquid spray, an atomizer, a nebulizer, an aerosol, steaming, soaking or infusing. In still further embodiments, providing a garment preparation comprises providing a garment preparation comprising microcapsules. In some embodiments, providing a garment preparation comprises providing a garment preparation comprising microcapsules, the microcapsules adapted to release their contents in response to a mechanical, thermal, or chemical stimulus. In further embodiments, providing a garment preparation comprises providing a garment preparation comprising any one of: a topical treatment for skin, transdermal skin treatment, a corticosteroid, a rubefacient, an anti-irritant, an antihistamine, an anti-allergy treatment, an anti-inflammatory treatment, an anesthetic or an analgesic. In yet further embodiments, providing a garment preparation comprises providing a garment preparation adapted to be applied to the garment by the wearer. In still further embodiments, the plurality of zones further comprises a third zone of the plurality of zones, the third zone applying a non-directional compressive force against the wearer during wear to enhance the health benefit.

In some aspects, the present disclosure relates to a health laundry method. The method may include a step of introducing a garment into a mechanical laundry machine. The garment may be configured to impart a health benefit to the wearer by exerting at least one compressive force to the wearer during wear of the garment, the at least one compressive force exerted by a plurality of garment zones, and the plurality of garment zones ergonomically disposed on the garment. The method may also include the step of introducing a garment treatment into the mechanical laundry machine, the garment treatment adapted to enhance the health benefit to a wearer of the garment during wear. The method may include the step of initiating a cycle of the mechanical laundry machine and after the completion of the cycle, wearing the garment.

In some embodiments, the mechanical laundry machine is a clothes washer. In some embodiments, the mechanical laundry machine is a clothes dryer. In some embodiments, the garment is configured to impart a slimming health benefit, and the garment treatment is adapted to enhance the slimming health benefit. In certain embodiments, the garment is configured to impart a visible cellulite reduction health benefit, and the garment treatment is adapted to enhance the visible cellulite reduction health benefit. In yet further embodiments, the garment is configured to impart a muscle tone improvement health benefit, and the garment treatment is adapted to enhance the muscle tone improvement health benefit.

In some embodiments, the garment is configured to impart a skin condition improvement health benefit, and the garment treatment is adapted to enhance the skin condition improvement health benefit. In further embodiments, the garment is configured to impart an energy increase health benefit, and the garment treatment is adapted to enhance the energy increase health benefit. In yet further embodiments, the garment is configured to impart a muscle pain relief health benefit, and the garment treatment is adapted to enhance the muscle pain relief health benefit. In some embodiments, the garment treatment comprises a microparticle. In other embodiments, the garment treatment comprises a one of, or any combination of: a liquid, a solid, a cream or a powder. In some embodiments, the garment treatment comprises a microcapsule adapted to release its contents in response to a mechanical, thermal, or chemical stimulus. In some embodiments, the garment treatment comprises one of, or a combination of: a topical treatment for skin, transdermal skin treatment, a corticosteroid, a rubefacient, an anti-irritant, an antihistamine, an anti-allergy treatment, an anti-inflammatory treatment, an anesthetic or an analgesic. In certain embodiments, at least one compressive force is non-directional.

### BRIEF DESCRIPTION OF THE FIGURES

FIG. 1 is a schematic diagram of a component of a system according to the present invention.

FIG. 2 is a diagram of front, back and side views of a system according to the present invention.

FIG. 3 is a diagram of front and back views of a system according to the present invention.

FIG. 4 is a diagram of front, back, and side views of a system according to the present invention.

FIG. 5 is a diagram of front, back, and side views of a system according to the present invention.

FIG. 6 is a diagram of front, back, and side views of a system according to the present invention.

FIG. 7 is a diagram of front and back views of a system according to the present invention.

FIG. 8 is a diagram of front, back, and side views of a system according to the present invention.

FIG. 9 is a diagram of front and back views of a system according to the present invention.

FIG. 10 is a chart of results of a method according to the present invention.

FIG. 11 is a front view diagram of a component of a system according to the present invention.

FIG. 12 is an oblique view diagram of a component of a system according to the present invention.

FIG. 12a is a side cut away view of the component of FIG. 11.

FIG. 13 is an oblique view diagram of a component of a system according to the present invention.

FIG. 14 is an oblique view diagram of a component of a system according to the present invention.

FIG. 15 is an oblique view diagram of a component of a system according to the present invention.

FIG. 16 is an oblique view diagram of a component of a system according to the present invention.

FIG. 17 is a side view diagram of a component of a system according to the present invention.

FIG. 18 is an oblique view diagram of a component of a system according to the present invention.

FIG. 19 is a front view diagram of a component of a system according to the present invention.

FIG. 20 is a side view diagram of a component of a system according to the present invention.

FIG. 21 is a front view diagram of a component of a system according to the present invention.

FIG. 22 is a side view diagram of a component of a system according to the present invention.

### DETAILED DESCRIPTION

### A. Health Benefit Compression Garments

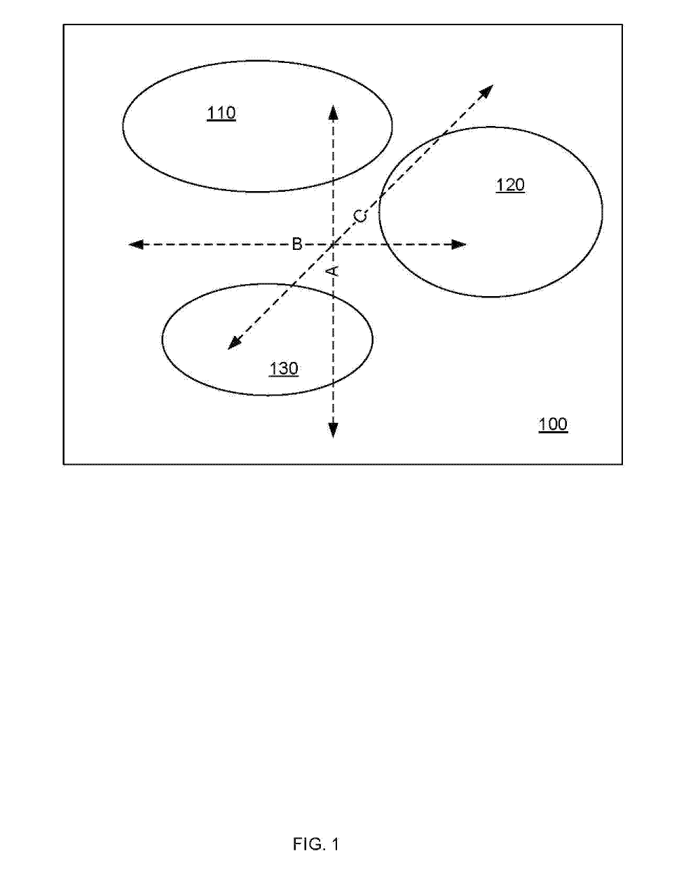

Compression textiles as used in embodiments of the present invention may have various compression characteristics including one or more compression directions, one or more compression regions, and one or more compression forces. FIG. 1 illustrates a piece of a compression textile 100. A compression direction for a particular textile as used herein refers to a direction along which a given linear measure of the textile, along the compression direction, will exhibit a repeatable, elastic deformation or “stretch” under the influence of a tensile force along the compression direction, of at least 25% of the given linear measure, without permanently altering or damaging the textile. Each compression direction can have an associated compression force. As used herein, compression force refers to the average tensile force required to stretch the textile along the compression direction to 125% of its original extent.

For example, compression textile 100 has compression directions A, B, and C, as well as an infinite number of other compression directions within the plane of the textile (not shown). For any given compression textile 100, compression directions A, B, and C can have associated compression forces Fa, Fb, and Fc, respectively. For any given compression textile 100, Fa, Fb, and Fc can be equal (non-directional textile) or different (directional). Further, compression textile 100 can have one or more compression regions, such as compression regions 110, 120, and 130. Each compression region can have different compression characteristics in the same garment. For example Fc within compression region 130 may differ from Fc within compression region 120, and Fa within compression region 110 may differ from Fa within compression region 130.

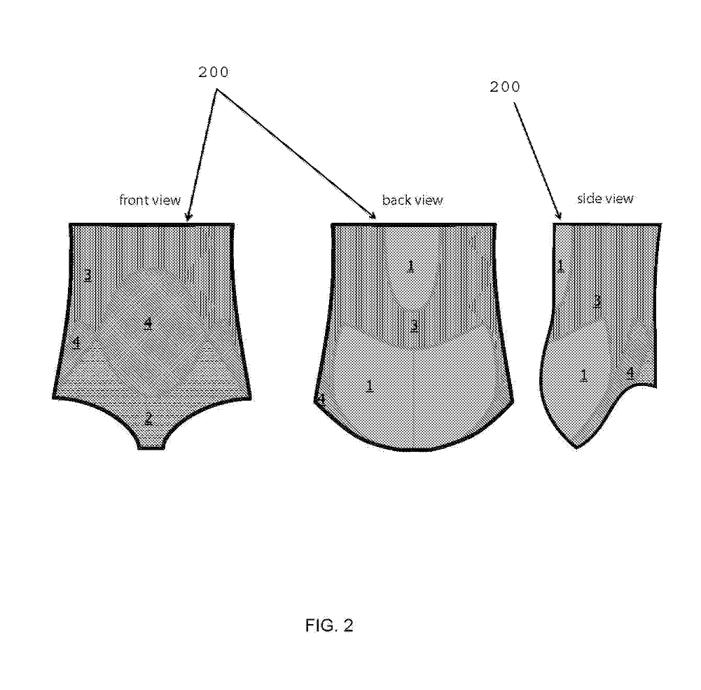

Several exemplary embodiments of the present invention are presented in detail below. FIG. 2 illustrates a front view, back view, and side view of an embodiment of an exemplary cosmetocompression tummy shaper garment 200 according to the present invention. Tummy shaper garment 200 is made from nylon Spandex and is designed to achieve a slimming effect for the wearer, for example to reduce cellulite in the buttocks, over the tummy area, the hips region, as well as to reduce “love handles.” Tummy shaper garment 200 can be used with a variety of cosmoceutical or other garment treatments, depending on the goals of the wearer, including for example, a microcapsule caffeine treatment, red algae treatment, or green tea treatment. Tummy shaper garment 200 may be adapted for wear by male or female wearers, or may be configured for unisex wear. Tummy shaper garment 200 uses four different fabric weaves of increasing compression force: non-directional fine jersey stretch; non-directional oxford compression; directional 2×1 rib compression; and non-directional diamond compression weave. Other embodiments of tummy shaper or similar garments can use fewer, more or different fabric types, such as a single type. Tummy shaper garment 200 is formed without seams, and is constructed from a single piece of fabric with different regions having distinct compression characteristics. Other embodiments can be formed from multiple panels of fabric, for example joined by seams or sewn joints. Other embodiments of similar garments according to the present invention may use different materials and fabrics, and employ different resistance and compression schemes depending on the goals of the garment.

As illustrated in FIG. 2, tummy shaper garment 200 uses a fine jersey stretch fabric (1) over the buttocks region of the garment. This area of the garment can be treated with a cellulite reducing preparation, a toning preparation, or another treatment as needed or desired. As illustrated, tummy shaper garment 200 also uses a fine jersey stretch fabric (1) over the lower, mid back region. The fine jersey stretch fabric can allow for natural shaping and light compression for wearing under other garments. Some embodiments of tummy shaper garment 200 can use a power mesh fabric over the lower back region or other high perspiration areas, to provide medium compression and breathability in such zones for maximum cooling. Tummy shaper garment 200 features a non-directional oxford compression fabric (2) region in the anterior pelvic area, which can provide a combination of comfort and support. The oxford compression fabric can provide medium compression and provide better lower abdomen support. Tummy shaper garment 200 features a directional rib compression fabric (3) over the peripheral abdominal region, lower back, and lateral torso region. The directional rib compression fabric is oriented with the compression direction circumferentially around the wearer's torso, and can provide resistance to the associated muscles, supporting muscle tone and caloric burn. The directional rib compression fabric can provide firm compression, creating a slimming effect and help with caloric burn and enhance the effect of any garment treatment. Tummy shaper garment 200 features a non-directional diamond compression (4) region over the abdominal area to provide relatively higher compression in this area and provide resistance for toning to the abdominal muscles. Tummy shaper garment 200 further employs non-directional diamond compression (4) region under the buttocks area to ensure adequate lift and support and to ensure that the buttocks panels remain in uniform contact with the buttocks of the wearer, ensuring uniform release of the garment treatment across the affected area. The diamond compression knit can provide extra firm compression and resistance for the abdominal muscles, and increases muscle workout efficiency and thus caloric burn.

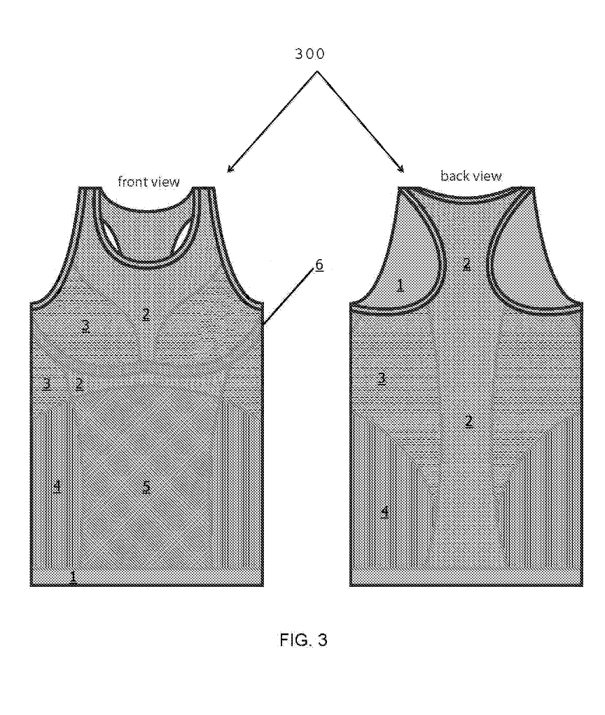

FIG. 3 illustrates a front view and a back view of an embodiment of an exemplary cosmetocompression tank top garment 300 according to the present invention. Tank top garment 300 illustrates several different regions of fabric having different characteristics and placed in different locations on the garment to achieve a slimming effect. Tank top garment 300 can be used with a variety of cosmoceutical or other garment treatments, depending on the goals of the wearer, including for example, a microcapsule caffeine treatment, red algae treatment, green tea treatment, or a retinol treatment, for example for the treatment of acne, or a metabolic enhancer such as a thermogenic or other mild nervous or circulatory stimulant. FIG. 3 illustrates that tank top garment 300 has a tummy power panel, mesh panels for breathability, and breast support panels. Other embodiments of tank tops according to the present invention may use a single fabric having a single compression force. Tank top garment 300 is constructed without seams from a single piece of synthetic fabric, employing different weaves in different areas to create different compression characteristics.

Tank top garment 300 uses six different weaves of increasing compression force: non-directional fine jersey stretch 1; non-directional mesh 2; non-directional oxford compression 3; directional 2×1 rib compression 4; non-directional diamond compression 5; and directional lifting resistance band 6. Other embodiments of tank tops according to the present invention may use fewer or more panels of differing compression. Tank top garment 300 uses non-directional mesh 2 which can provide medium compression and breathability in high perspiration zones for maximum cooling. Tank top garment 300 uses oxford compression fabric 3 which can provide medium compression and provide better bust support for active sport use. Tank top garment 300 can use resistance lifting bands 6 to hold the wearer's bust in place and shape the underbust, and provide figure flattering. Tank top garment 300 uses diamond compression fabric 5 to provide extra firm compression and resistance for the abdominal muscles, and increase muscle workout efficiency and thus caloric burn. Tank top garment 300 uses directional rib compression fabric 4 for firm compression, which can create a slimming effect and help with caloric burn and enhance the effectiveness of any garment treatment used. Other embodiments of similar garments according to the present invention may use different materials and fabrics, and employ different resistance and compression schemes depending on the goals of the garment.

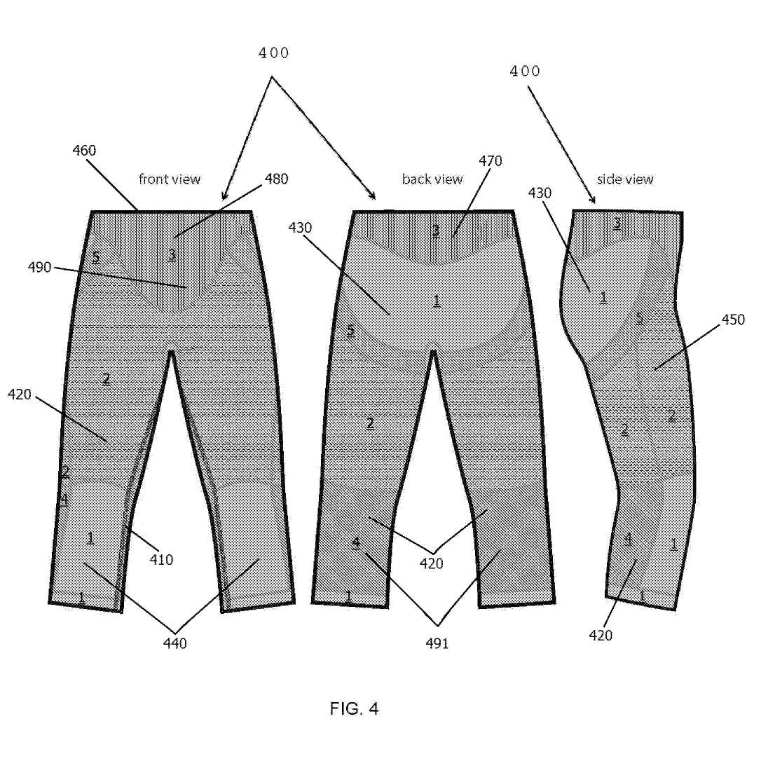

FIG. 4 illustrates a front view, a back view, and a side view of an embodiment of an exemplary cosmetocompression Capri pant garment 400 according to the present invention. Capri pant garment 400 is configured to provide skin and muscle toning and visible cellulite reduction results to a wearer, and is designed to be used with various garment treatments such as metabolic enhancers, thermogenic formulas, caffeine or green tea-infused treatments, red algae treatments, or other anti-cellulite and skin and muscle toning treatments. Capri pant garment 400 is constructed with an inseam joint but no other joints. The inseam joint 410 of Capri pant garment 400 is moved slightly forward from the midline of the leg shaft 420, in order to minimize chafing and reduce seam wear in use. In various embodiments of garments according to the present invention having an inseam, the inseam can be disposed substantially along a leg midline, can be shifted forward or behind the leg midline, or can be provided on the outside of the legs instead of the inner leg area. Other embodiments of Capris according to the present invention can be constructed in several panels joined by seams, or from a single piece of material with no seams. Capri pant garment 400 is adapted primarily for wear by women, but other embodiments of Capris or similar garments according to the present invention may be adapted for wear by men, women, children or for unisex wear.

As shown in FIG. 4, Capri pant garment 400 uses five different fabric materials, in increasing order of compression force: non-directional fine jersey stretch 1; non-directional oxford compression 2; directional 2×1 rib compression 3; non-directional diamond compression 4; and, directional lifting resistance band 5. Other embodiments of Capris and similar garments may use fewer or more different regions of fabrics having fewer or more different compression characteristics.

Capri pant garment 400 uses a non-directional fine jersey stretch fabric 1 in the buttocks 430 and across the shin regions 440, providing comfortable support across these regions without excessive compression in these areas. The non-directional fine jersey stretch fabric 1 can allow for natural shaping and light compression. Capri pant garment 400 uses an oxford compression fabric 2 around the thigh of the garment 450, providing comfortable compression to enhance the activity of the cosmoceuticals or other garment treatment used. The oxford compression fabric 2 can provide medium compression to provide better muscle performance, thus caloric burn and reduce muscle fatigue. Capri pant garment 400 uses a directional 2×1 rib compression fabric 3 across the waist 460, lower back 470, and upper pelvis area 480, to provide a snug and supportive fit, and to provide resistance across the lower abdomen 490 to increase the caloric burn and toning of the associated muscles of the wearer. Directional 2×1 rib compression fabric 3 can provide firm compression, creating a slimming effect and help with caloric burn and enhance the effects of any garment treatments used. Capri pant garment 400 further uses non-directional diamond compression fabric 4 on the calf region 491, in order to provide increased resistance and toning to this region, for example to increase the calf muscle definition of the wearer. The non-directional diamond compression fabric 4 can provide extra firm compression and resistance for the abdominal muscles, can increases muscle workout efficiency and thus caloric burn. Capri pant garment 400 uses a directional lifting resistance band fabric 5 under the buttocks 430 to support this region and provide lift, as well as to maintain the buttocks 430 in uniform contact with the buttocks of the wearer, to ensure uniform release of the garment treatment across the buttock region of the wearer. Other embodiments of similar garments according to the present invention may use different materials and fabrics, and employ different resistance and compression schemes depending on the goals of the garment.

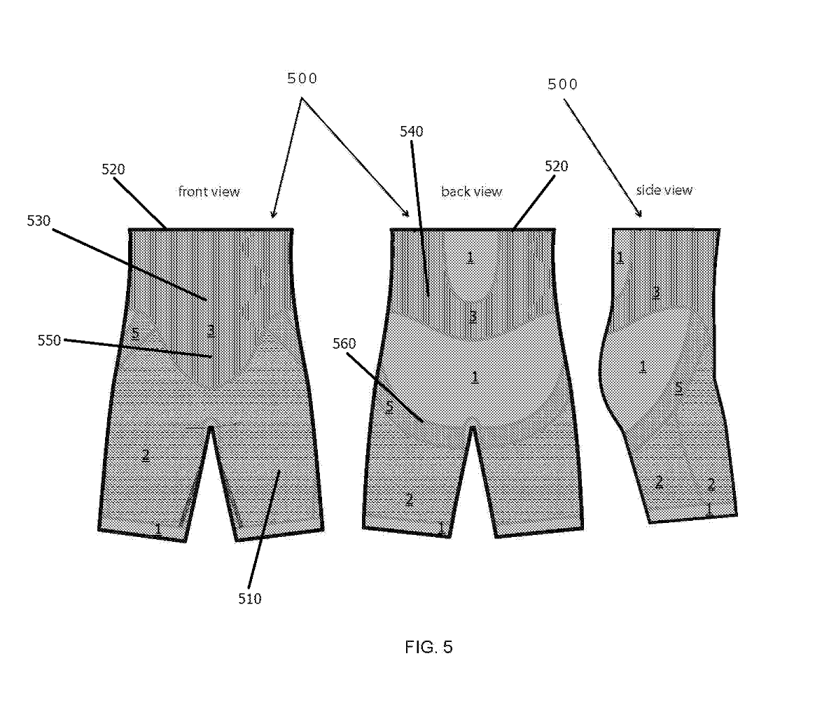

FIG. 5 illustrates a front view, a back view, and a side view of an exemplary cosmetocompression thigh slimmer garment 500 according to the present invention. Thigh slimmer garment 500 is configured to provide skin and muscle toning and visible cellulite reduction results to a wearer, and is designed to be used with various garment treatments including metabolic enhancers, thermogenic formulas, caffeine or green tea-infused treatments, red algae treatments, or other anti-cellulite and skin and muscle toning treatments. Thigh slimmer garment 500 is constructed with an inseam joint 510 but no other joints. The inseam joint 510 of thigh slimmer garment 500 is moved slightly forward from the midline of the leg shaft 520, in order to minimize chafing and reduce seam wear in use. In various embodiments of thigh slimmers according to the present invention having an inseam, the inseam can be disposed substantially along the thigh centerline, can be shifted forward or behind the thigh centerline, or can be provided on the outside of the thighs instead of the inner thigh area. Other embodiments of thigh slimmers according to the present invention can be constructed in several panels joined by seams, or from a single piece of material with no seams. Thigh slimmer garment 500 is adapted for wear by women, but other embodiments of thigh slimmers or similar garments according to the present invention may be adapted for wear by men, women, children or for unisex wear.

Thigh slimmer garment 500 uses four different fabric materials, in increasing order of compression force: non-directional fine jersey stretch 1; non-directional oxford compression 2; directional 2×1 rib compression 3; and a directional lifting resistance band 4. Other embodiments of thigh slimmers and similar garments may use fewer or more different regions of fabrics having fewer or more different compression characteristics.

Thigh slimmer garment 500 uses a non-directional fine jersey stretch fabric 1 in the buttocks and across the small of the back, providing comfortable support across these regions without excessive compression. The fine jersey fabric 1 can allow for natural shaping and light compression for wearing under other garments. Some embodiments of a thigh slimmer according to the present invention can use a power mesh fabric over the lower back region or other high perspiration areas, to provide medium compression and breathability in such zones for maximum cooling. Thigh slimmer garment 500 uses a non-directional oxford compression fabric 2 around the thigh 510 of the garment, providing comfortable compression to enhance the activity of the cosmoceuticals or other garment treatment used. The non-directional oxford compression fabric 2 can provide medium compression to provide better muscle performance, thus caloric burn, and to reduce muscle fatigue. Thigh slimmer garment 500 uses a directional 2×1 rib compression fabric 3 across the waist 520 and abdomen 530, lower back 540, and upper pelvis area 550 to provide a snug and supportive fit, and to provide resistance across the lower abdomen of the wearer to increase the caloric burn and toning of the associated muscles of the wearer. The directional 2×1 rib compression 3 can provide firm compression, creating a slimming effect and help with caloric burn and enhance the effect of any garment treatment used. Thigh slimmer garment 500 uses a non-directional diamond compression fabric 4 around the thighs 510 to provide resistance to the major thigh muscle groups, resulting in toning. The non-directional diamond compression fabric 4 can provide extra firm compression and resistance and lift to the gluteus and abdominal muscles of a wearer. Thigh slimmer garment 500 uses a directional lifting resistance band fabric 5 under the buttocks 560 to support this region and provide lift, as well as to maintain the buttocks regions 560 in uniform contact with the buttocks of the wearer, to ensure uniform release of the garment treatment across the buttock region of the wearer. Other embodiments of similar garments according to the present invention may use different materials and fabrics, and employ different resistance and compression schemes depending on the goals of the garment.

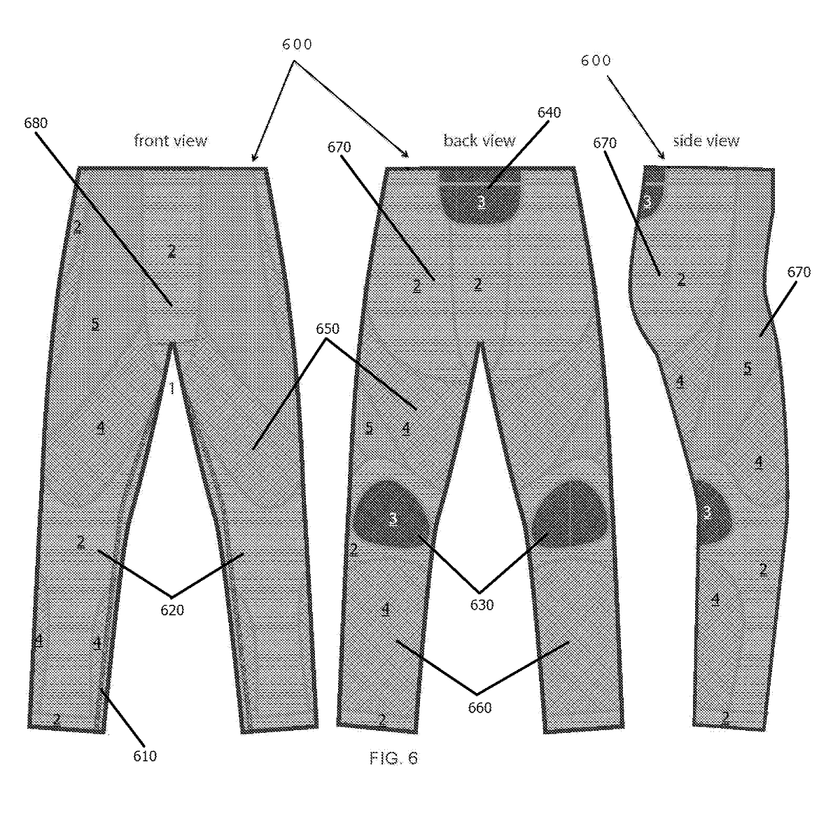

FIG. 6 illustrates a front view, a back view, and a side view of an exemplary cosmetocompression tights 600 according to the present invention. Cosmetocompression tights 600 of FIG. 6 are configured to be worn primarily by men, but similar garments according to the present invention may be configured for wear by female wearers and for children. Cosmetocompression tights 600 features semi-seamless construction with only one inseam 610. The inseam 610 is shifted forward of the leg 620 centerline in order to reduce chafing and decrease seam wear during use. In other embodiments of tights or similar garments according to the present invention, the garment is constructed entirely from one piece of textile with no seams. In various embodiments having an inseam, the inseam can be disposed substantially along a thigh centerline, can be shifted forward or behind a thigh centerline, or can be provided on the outside of the legs instead of an inner leg area. Cosmetocompression tights 600 feature different regions of fabric having differing compression characteristics to achieve a skin toning and body slimming effect in a wearer. The tights use several directional resistance regions to provide excellent torso and “core” strengthening benefits, particularly when worn during another activity, such as when playing basketball or another sport, and can be worn as a base layer for enhancing a workout or sports session. Cosmetocompression tights 600 can be used with a variety of cosmoceutical or other garment treatments, depending on the goals of the wearer, including for example, a microcapsule caffeine treatment, red algae treatment, green tea treatment, or a metabolic or performance enhancer such as a thermogenic or other mild nervous or circulatory stimulant.

Cosmetocompression tights 600 use four fabrics of increasing compression force: a non-directional oxford compression fabric 2; a non-directional open mesh 3, which offers cooling characteristics; a non-directional diamond compression fabric 4; and a non-directional resistance fabric 5. Cosmetocompression tights 600 uses non-directional oxford compression fabric 2 for the buttocks 670 and crotch 680 for comfortable support and freedom of movement of a wearer. Non-directional oxford compression fabric 2 can provide medium compression to provide support while providing enough “give” for comfort. Cosmetocompression tights 600 uses non-directional open mesh 3 fabric in the high perspiration areas behind the knees 630 and over the small of the back 640 for enhanced cooling and wearing comfort. The non-directional open mesh 3 fabric can provide medium compression and breathability in high perspiration zones for maximum cooling.

Cosmetocompression tights 600 uses a non-directional diamond compression fabric 4 across the back and front of the thighs 650 and over the calves 660 to support the surrounding directional resistance materials and to build core strength in the major leg muscle groups of the calves, quadriceps and the hamstrings of the wearer. The non-directional diamond compression fabric 4 can provide extra firm compression and resistance, and helps to enhance muscle performance, thus caloric burn and reduce muscle fatigue. The tight uses non-directional high-resistance fabric 5 over the upper thigh 670, to provide toning resistance to core muscle groups of the wearer.

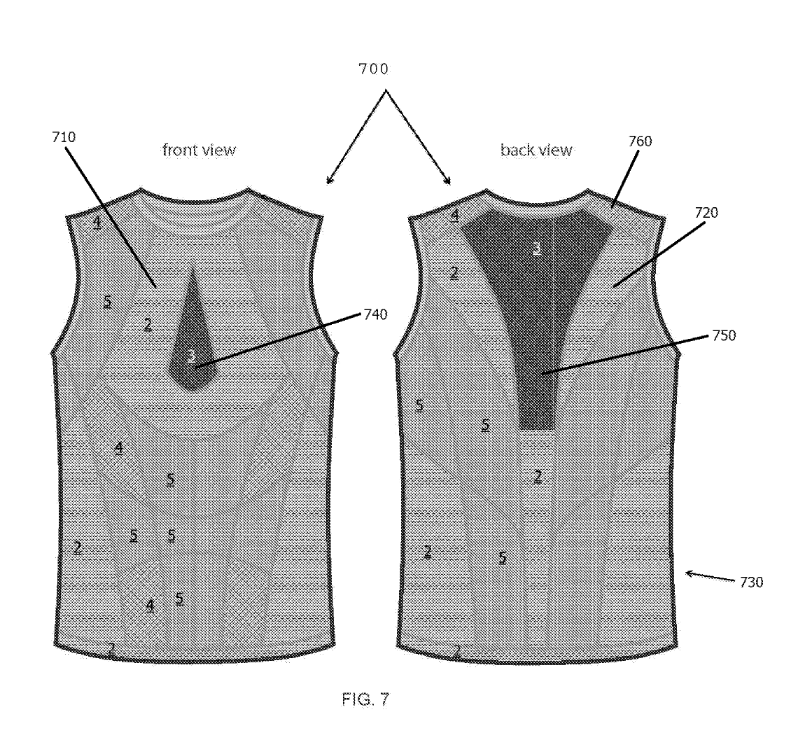

FIG. 7 illustrates a front view and a back view of an exemplary cosmetocompression sleeveless tee 700 according to the present invention. Cosmetocompression sleeveless tee 700 is configured for wear by men or women, and features seamless construction with different regions of fabric having differing compression characteristics to achieve a skin toning and body slimming effect in a wearer. Cosmetocompression sleeveless tee 700 uses several directional resistance regions to provide excellent torso and “core” strengthening benefits, particularly when worn during another activity, such as when playing basketball or another sport, and can be worn as a base layer for enhancing any workout or sports session. Cosmetocompression sleeveless tee 700 can be used with a variety of cosmoceutical or other garment treatments, depending on the goals of the wearer, including for example, a microcapsule caffeine treatment, red algae treatment, green tea treatment, or a retinol treatment, for example for the treatment of acne or scarring, or a metabolic enhancer such as a thermogenic or other mild nervous or circulatory stimulant. Cosmetocompression sleeveless tee 700 uses four different types of fabrics across several regions, specifically targeting the characteristics of the fabric to the needs of the corresponding body region of a wearer.

Cosmetocompression sleeveless tee 700 uses four fabrics of increasing compression force: a non-directional oxford compression fabric 2; a non-directional open mesh 3 for cooling; a non-directional diamond compression fabric 4; and a non-directional plain jersey stretch fabric having several directional resistance bands 5. Cosmetocompression sleeveless tee 700 uses non-directional oxford compression fabric 2 in the upper chest 710, upper back 720, and lateral torso 730 for a snug fit and freedom of movement. The non-directional oxford compression fabric 2 can provide medium compression for support while provide enough “give” for comfort. Cosmetocompression sleeveless tee 700 uses non-directional open mesh 3 fabric in high perspiration areas such as between the pectoral muscles 740 and the mid back area 750 for enhanced cooling and wearing comfort. The non-directional open mesh 3 can provide medium compression and breathability for maximum cooling. Cosmetocompression sleeveless tee 700 uses a non-directional diamond compression fabric 4 on the upper shoulders 760 to support the surrounding directional resistance materials. The non-directional diamond compression fabric 4 can provide extra firm compression and resistance and helps to enhance muscle performance, thus caloric burn, and reduces muscle fatigue. Cosmetocompression sleeveless tee 700 uses a non-directional plain jersey stretch fabric having several directional resistance bands 5 across much of the torso 730, to provide toning resistance to “core” areas of the abdomen and back of a wearer, as well as the upper shoulder and chest of a wearer.

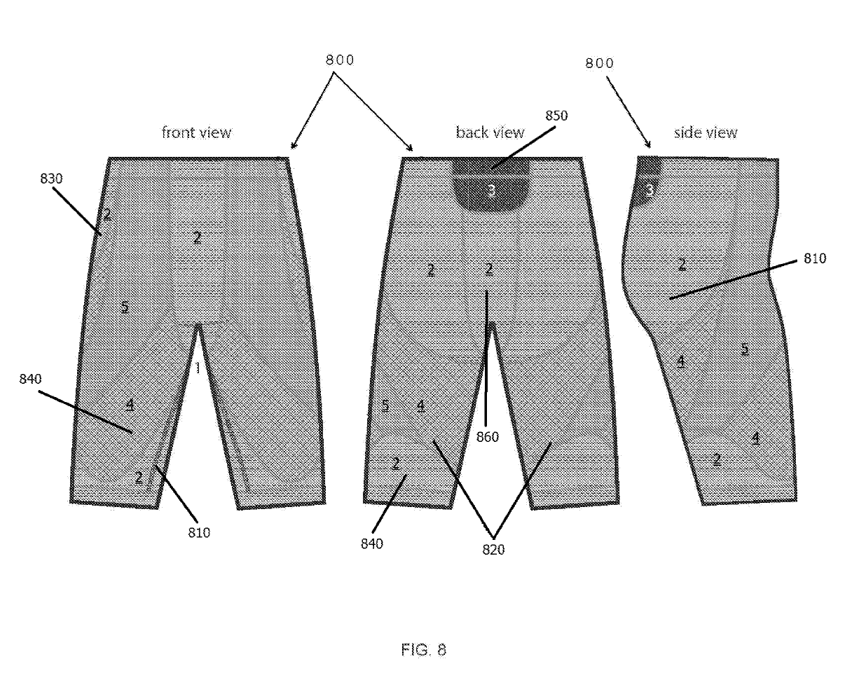

FIG. 8 illustrates a front view, a back view, and a side view of an exemplary cosmetocompression shorts 800 according to the present invention. Cosmetocompression shorts 800 are configured to be worn primarily by men, but similar garments according to the present invention may be configured for wear by female wearers and for children. Cosmetocompression shorts 800 feature semi-seamless construction with only one inseam 810. The inseam 810 is shifted forward of the leg 820 centerline in order to reduce chafing and decrease seam wear during use. In other embodiments of shorts or similar garments according to the present invention, the garment is constructed entirely from one piece of textile with no seams. In various embodiments having an inseam, the inseam can be disposed substantially along a thigh centerline, can be shifted forward or behind a thigh centerline, or can be provided on the outside of the legs instead of an inner thigh area. Cosmetocompression shorts 800 feature different regions of fabric having differing compression characteristics to achieve a skin toning and body slimming effect in a wearer. Cosmetocompression shorts 800 use several directional resistance regions to provide excellent torso and “core” strengthening benefits, particularly when worn during another activity, such as when playing basketball or another sport, and can be worn as a base layer for enhancing a workout or sports session. Cosmetocompression shorts 800 can be used with a variety of cosmoceutical or other garment treatments, depending on the goals of the wearer, including for example, a microcapsule caffeine treatment, red algae treatment, green tea treatment, or a metabolic enhancer such as a thermogenic or other mild nervous or circulatory stimulant.

Cosmetocompression shorts 800 use four fabrics of increasing compression force: a non-directional oxford compression 2; a non-directional open mesh 3 for cooling; a non-directional diamond compression fabric 4; and, a non-directional plain jersey stretch fabric equipped with several directional resistance bands 5. Cosmetocompression shorts 800 use non-directional oxford compression fabric 2 for the buttocks 810, groin 860, hips 830, and lower thighs 840 for a snug fit and freedom of movement. The non-directional oxford compression fabric 2 can provide medium compression to provide support while providing enough give for comfort. Cosmetocompression shorts 800 uses non-directional mesh 3 fabric in high perspiration areas such the small of the back 850 for enhanced cooling and wearing comfort. The non-directional mesh 3 can provide medium compression and breathability in high perspiration zones for maximum cooling. Cosmetocompression shorts 800 use non-directional diamond compression fabric 4 across the back and front of the thighs 840 to support the surrounding directional resistance materials. The non-directional diamond compression fabric 4 can provide extra firm compression and resistance, and help to enhance muscle performance, thus caloric burn, and to reduce muscle fatigue. Cosmetocompression shorts 800 use a non-directional plain jersey stretch fabric equipped with several directional resistance bands 5 across much of the lateral thighs and pelvic area, to provide toning resistance to “core” muscle groups of the thigh such as the quadriceps, hips, as well as the hamstrings.

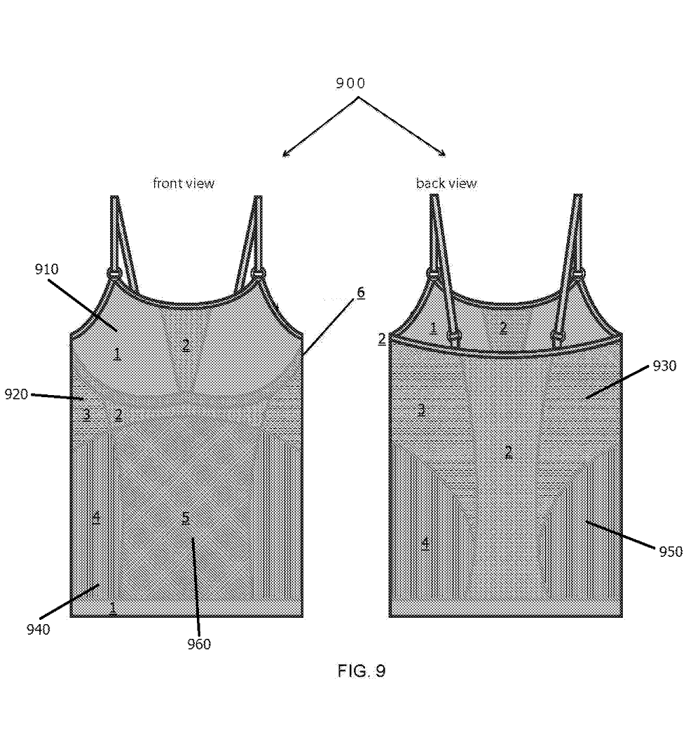

FIG. 9 illustrates a front view and a back view of an embodiment of an exemplary camisole garment 900 according to the present invention. The camisole garment 900 is a cosmetocompression garment providing slimming effects to the wearer, and is particularly configured to be worn by female users. The camisole garment 900 has ergonomically placed compression panels to target muscles groups for efficient muscle usage, providing greater caloric burn. The camisole garment 900 can be provided with a garment treatment to achieve skin toning while reducing the appearance of cellulite. The camisole garment 900 can be used with a variety of cosmoceutical or other garment treatments, depending on the goals of the wearer, including for example, a microcapsule caffeine treatment, red algae treatment, green tea treatment, or a retinol treatment, for example for the treatment of acne. The camisole garment 900 may be worn, for example, as a sleeping garment to provide salutary benefits while the wearer sleeps. The camisole garment 900 can also provide lift and support, as well as control. The camisole garment 900 is seamless in construction, with different compression regions of the garment employing different fabric weaves in one unbroken piece of fabric. Other embodiments of similar garments according to the present invention may use different materials and fabrics, employ different resistance and compression schemes depending on the goals of the garment. The exemplary camisole is constructed of a stretch nylon, but other embodiments may be made from other textiles to achieve the same or similar results.

In some embodiments, a garment can be formed from separate panels having differing compression that are joined together. As shown, camisole garment 900 has six different compression regions, in order of increasing compression force: non-directional fine jersey stretch 1; non-directional mesh 2; non-directional oxford compression 3; directional 2×1 rib compression 4; non-directional diamond compression 5; and directional lifting resistance band 6. In various embodiments, materials having higher compression force can be used in garment regions requiring more support or resistance. The camisole garment 900 is configured to be used with a garment treatment providing a slimming effect and which can be applied by the end user, and periodically renewed, for example by introducing a treatment renewal preparation into the laundry during the washing of the exemplary camisole. The exemplary camisole features a built in shelf bra for extra support.

For example, the exemplary camisole uses a line jersey stretch fabric 1 over the breast region 910 of the garment. The fine jersey stretch fabric 1 allows for natural shaping and light compression for wearing under other garments. The camisole garment 900 uses a mesh weave 2 for comfort in some areas, where little to no slimming effect is needed. The mesh weave 2 can provide medium compression and breathability in high perspiration zones for maximum cooling. The camisole garment 900 uses non-directional oxford compression 3 in the underarm 920 and upper back regions 930, where moderate compression may be desired to achieve a slimming effect, but where too much compression could compromise wearing comfort. The non-directional oxford compression 3 can provide medium compression and provide good bust support. Around the upper hip 940 and lateral torso region 950, the camisole garment 900 uses directional 2×1 rib compression 4, with the primary compression direction oriented laterally around the wearer's torso. The directional 2×1 rib compression 4 can provide firm compression, creating a slimming effect and help with caloric burn as well as enhance the effect of any garment treatments used. This area of the camisole garment 900 is configured to provide significant slimming effects. The camisole garment 900 uses a non-directional diamond compression fabric 5 panel across the abdominal region 960, offering relatively high resistance and compression to this area to work with the garment treatment to provide high levels of slimming activity. The non-directional diamond compression fabric 5 provides extra firm compression and resistance for the abdominal muscles of a wearer, and increases muscle workout efficiency and thus caloric burn. The camisole garment 900 uses a directional lifting resistance band 6 under the breast region 910, not for slimming but rather for support, and to maintain the camisole garment 900 against the wearer's body across the breast 910 and abdominal region 960. The directional lifting resistance band 6 can work to hold in place and shape the underbust for a more flattering figure.

In addition to the exemplary embodiments presented in detail herein, the present invention comprehends several further embodiments of cosmetocompression garments. For example, another embodiment of the present invention is a pre-surgical garment provided with a local anesthetic. Other pre-operative embodiments according to the present invention include garments provided with a garment treatment that has an antibacterial, antiviral, or antiseptic activity, such as garments provided with a silver garment treatment. In such embodiments, the compression component of the cosmetocompression garment can stimulate circulation, enhancing the effectiveness of the analgesic or anesthetic garment treatment. Such embodiments of pre-operative cosmetocompression garments can include nanoparticle technology for delivery of preoperative nanopharmaceuticals. In such embodiments, the compressive aspect of the present invention ensures uniform delivery of the pre-surgical treatment over the affected area, and may reduce the need for general anesthesia.

Embodiments of the present invention may include garments for post operative wear. For example, embodiments of the present invention can incorporate garment treatments for scar mitigation, for example for use by patients of cosmetic surgery, or for post caesarian-section care. Embodiments of the present invention may be configured to uniformly deliver time release pharmaceuticals either topically or transdermally to prevent post-op infection, such as via garment treatments including antibiotics, sulfur preparations, silver preparations, or other preparations as are known in the medical arts. A further, post operative embodiment releases an anti-itching preparation to the patient to discourage scratching, speed healing, reduce infection from scratching, and increase patient comfort. In such embodiments, the compressive aspect of the present invention ensures uniform delivery of the treatment over the affected area.

Some embodiments of the present inventive cosmetocompression garments are adapted to treat chronic medical conditions, such as diabetes, edema, vascular disease, varicose veins, or another health problem. Such embodiments are configured to deliver pharmacological preparations along with mechanical compression to the affected regions of the body to achieve a therapeutic and palliative result. In such embodiments, the compressive aspect of the present invention ensures uniform delivery of the treatment over the affected area, and may reduce the need for systemic delivery, as well as providing the mechanical benefits of compression.

One exemplary embodiment of the present invention is a cosmetocompression garment for burn victims and skin graft patients. In such embodiments, the garment may be provided with antibacterial, antimicrobial, or antiseptic preparations, such as silver, to prevent infection. Such embodiments can also be provided with local anesthetics to be released during wear to alleviate the pain of the healing process. The patient's movement of the affected limb or body part, which movement may result in pain, can also trigger the release of additional anesthetics, for example though the breakage of embedded microcapsules, thereby providing pain relief as needed. One compressive aspect of such embodiments can be ensure that the garment remains in contact with the affected skin region during the course of healing.

In some cases of skin grafts, the donor tissue may not possess the desired elasticity for the area to which it is applied. Embodiments of the present invention for skin graft patients can be provided with time release skin preparations that provide all or some of the following activities: improve skin elasticity, improve skin integration to the surrounding tissue, fade graft scarring, and smooth graft scarring. Further, embodiments of the present cosmetocompression garments can release skin treatments when triggered by the patient's movement of the affected area, when the treatment is needed.

In some cases the muscles underlying the affected skin of burn victims may become atrophied as the patient's mobility is limited for an extended, initial healing period, or due to pain. Embodiments of the present cosmetocompression garments can provide muscle resistance to the patient in the affected area, thereby serving to restore the strength and tone of the atrophied muscle while simultaneously providing necessary dermal treatment to the affected overlaying skin.

A further application of the present inventive cosmetocompression garments is in the area of maternity wear. Exemplary embodiments of the present cosmetocompression garments can be provided with skin treatments to mitigate stretch marks. Some embodiments of the present invention, such as tights, may be provided with compression regions configured to reduce swelling, for example in the lower extremities such as ankles and calves. Such embodiments can also provide comfort and support to pregnant women, such as in the later periods of gestation.

A further application of the present inventive cosmetocompression garments includes post bariatric surgery or post weight loss garments. For example, when a person loses a significant amount of weight in an accelerated period, the person may experience large amounts of loose, hanging, or excess skin. Exemplary embodiments of the present cosmetocompression garments can be used to simultaneously physically control the excess skin for comfort, as well as to impart skin toning and tightening preparations to reduce the excess skin during wear.

A further exemplary embodiment of the present inventive cosmetocompression garments includes a post-operative physical therapy garment having muscle resistance and scar reducing activity. One embodiment is a leg sleeve for a knee surgery patient. For example, in one embodiment, the leg sleeve incorporates compression regions to provide resistance to knee articulation, to improve strength and tone of the post-operative, recovering leg, which may have atrophied. The exemplary embodiment may also incorporate scar mitigation regions around the knee area, which can use the cosmetocompression textile to release a bleaching or fading preparation, or to incorporate a dermabrasion element to smooth scarring.

A further exemplary embodiment of the present inventive garments is embedded with dermabrasion material, for example for scar mitigation, for example for body acne scar diminishment. Some embodiments combine dermabrasion activity with an active bleaching or fading cosmetoceutical preparation to rapidly diminish the appearance of scarring, such as results from acne, or from laser tattoo removal scarring. In various embodiments, dermabrasion can be provided by embedded minerals material, glass material, pumice, ground seeds, or other materials as are known in the art. In embodiments incorporating dermabrasion activity, the compression aspect of the inventive garment may enhance the dermabrasion effectiveness and uniformity by ensuring that the fabric is held against the affected skin evenly and with regular and consistent pressure.

As discussed in connection with FIG. 1, embodiments of the present invention can use fabrics having compression directions in one direction, and that are substantially unstretchable in a direction perpendicular to the compression direction (“directional” fabrics). Other fabrics may be used that have compression directions with substantially equivalent compression forces all directions (“non-directional”). Some embodiments of the present inventions can incorporate different overall garment compression characteristics by using panels of textiles having different compression directions, directionality, and compression forces, joined together. Some garment embodiments of the present inventions can use textiles having compression characteristics that vary across a seamless textile, which compression characteristics may, in various embodiments, be created through knitting, weaving, or other techniques.

Various methods are also the subject of the present invention. For example, the present invention includes methods for slimming (reducing the circumference of) a body part, such as thigh, waist, upper arm, etc. over the course of a period of time (the “reduction period”). In various embodiments of the method, reduction periods can be for various durations between 1 week and one year. The method includes the step of treating a cosmetocompression garment, such as according to the present invention, with a slimming treatment. For example, in embodiments of the present exemplary method, the user may treat the garment with a transdermal metabolic enhancer, an herbal slimming treatment, or another slimming treatment as is known in the cosmoceutical arts. The user then may put on the treated cosmetocompression garment to cover the body part to be slimmed. The user then proceeds to wear the treated cosmetocompression garment for at least 3 hours for each day during the reduction period. The user continues to wear the treated cosmetocompression garment for at least 3 days per week during the entire reduction period.

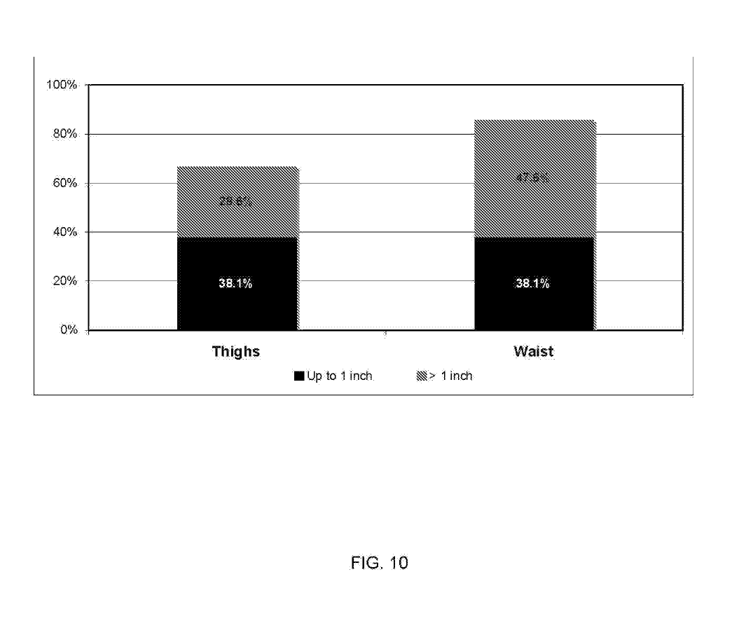

This method formed the subject of study demonstrating its effectiveness. The study was conducted on 30 women instructed to wear cosmetocompression garments, according to the invention disclosed herein, for 8 hours day or night for 4 weeks, for 6 days per week. After two weeks, the study participants were instructed to begin to recharge their cosmetocompression garments for subsequent wear. The study resulted in 68% of women seeing a reduction in their thigh circumference, with an average reduction of 0.5 inches. 33% (8 out of 27) experienced a reduction in thigh circumference after 4 weeks, of up to 1.75 inches, with an average of 0.04 inch. 64% (16 out of 25) experienced a reduction in thigh circumference after 6 weeks, of up to 1.75 inches-0.4 inch in average. 70% (19 out of 27) experienced a reduction in waist circumference after 4 weeks, of up to 3.0 inches-0.81 inch in average. 88% (22 out of 25) had a reduction in waist circumference after 6 weeks, of up to 3.25 inches-1.33 inch in average. FIG. 10 illustrates the results of the test. The study further showed that in a four week volunteer study, 19% average increase in skin firmness was measured.

### B. Laundry Treatment of Health Garments

Clothes cover a large part of the body for most of the day or night, presenting an ideal opportunity for the convenient transfer of cosmetics, pharmaceuticals, cosmetoceuticals, or other health or wellness treatments. Embodiments of the present inventions can use garment care processes, such as washing and drying, to infuse garments, such as specially adapted garments or “regular” garments, with garment treatments such as cosmetics, pharmaceuticals, cosmetoceuticals, or other treatments to yield health, wellness or fitness benefits in the wearer.

The capacity for garments treated according to the various embodiments of the present inventions to receive, retain, and release various cosmetic, wellness or pharmacological preparations may be a function of the textile fibers, or can be a result of post-manufacture processing, such as a permanent fiber surface treatment provided before or after the fibers are made into a textile, or during any coloring or dyeing process. In other embodiments, the inventive garment treatment systems and methods can be used to treat existing, “normal” garments of standard garment textiles as are known the clothing arts.

In various embodiments of the present garment treatment inventions, garments may be treated incident to laundering or cleaning the garment, for example during washing, drying, ironing, dry cleaning, or steaming. The present systems and methods may be used for initial garment treatment and for re-treatment or to “recharge” a garment. In various embodiments, garments treated according to the present systems and methods may have previously or initially been treated incident to manufacture, dyeing, garment construction, or as a part of a post garment construction step, or not previously been treated at all. The effectiveness of garments treated according the present invention may then be periodically renewed as necessary by the users by reapplying or redelivering the garment treatment according to the present systems and methods, to “recharge” them.

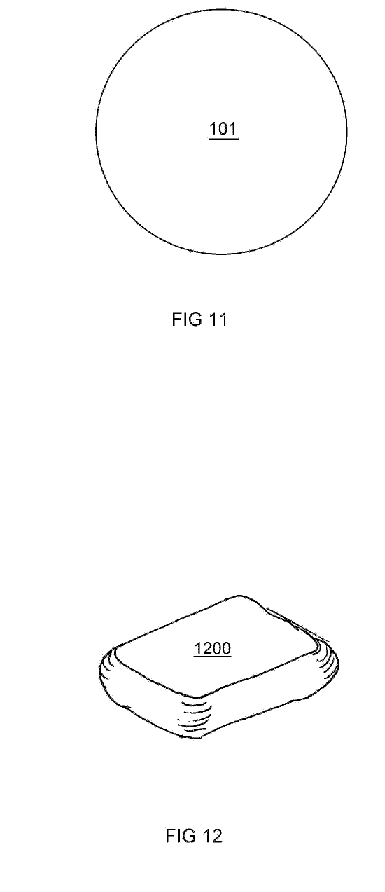

For example, one embodiment, illustrated in FIG. 11, is a water soluble washing machine packet 101 containing washing detergent and garment treatment in one. Another embodiment is a washing machine packet containing only garment treatment and no detergent. Some embodiments of washing machine packets can be configured to be added to the wash at the start of the wash cycle, for example in addition to any detergent to be used.

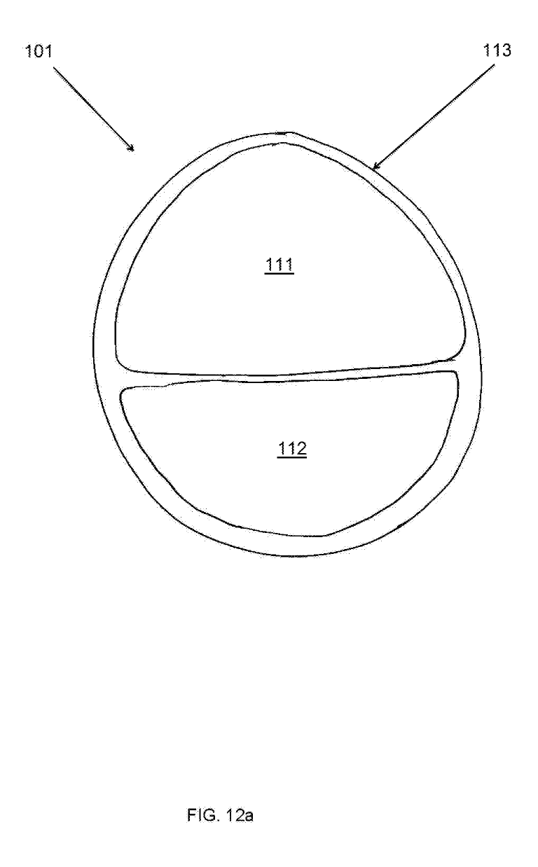

Washing machine packet 101 is spherical. Various embodiments of a washing machine packet can form various three dimensional shapes, such as a roughly spherical, ovoid, ellipsoid, cube, regular hexahedron, or other three dimensional shape. FIG. 12 illustrates washing machine packet 1200, which is shaped roughly like a bar of soap. Washing machine packets can have various volumes, from one cubic centimeter to fifty cubic centimeters, for example ten cubic centimeters. Some embodiments can have a shell enclosing an inner chamber, whereas other embodiments can be of roughly homogenous composition, with or without a thin outer membrane for storage and handling. In some embodiments, the washing machine packet can have a shell formed from water soluble material to allow the contents to be released into the wash during the wash cycle. Some embodiments of washing machine packets, in addition to active ingredients such as detergent, fabric softener, and garment treatments, can further contain fillers, such as inert filler substance, or other associated substances, for example a colorant, fragrance or rinse enhancer.

In some embodiments, the user can introduce the packet into the wash in place of conventional detergent products. Such embodiments can contain liquid detergent, powder detergent, gel detergent, or another form of laundry detergent as is known in the laundry arts. In such embodiments, the packet can be coated with or encased by a soluble shell, which can allow handling and transport of the packet without allowing the contents to escape, and which can dissolve in contact with the wash water, releasing the contents. Such packet embodiments can also include a garment treatment formula, such as in a liquid, powder, or other form. In various embodiments, the garment treatment formula can be mixed in with the detergent, or can be maintained separately in the packet, such as in a separated chamber or subcapsule within the packet. Such a chamber or subcapsule can be formed, for example by an extension of shell material to form a separating membrane within the packet. In some embodiments, the subcapsule or chamber surrounding the garment treatment formula can be formed from a thicker or more resistant material, so as to dissolve more slowly, thereby being released later in the wash cycle, such as during the rinse cycle.

FIG. 12a illustrates a side cut away view of washing machine packet 101. FIG. 12a illustrates that washing machine packet 101 has two internal chambers, detergent chamber 111 and garment treatment chamber 112. FIG. 12a further illustrates the shell of washing machine packet 101, shell 113.

During the wash cycle, embodiments of the washing machine packets can release garment treatment substances onto the laundry, which treatments can persist on the fabric and not be rinsed off in the rinse cycle. Some embodiments of the washing machine packets require that the garments be air dried in order to effectively retain their garment treatment. Other embodiments of the washing machine packets can release a garment treatment onto the garments that does not become degraded or separated from the garment during a subsequent machine drying cycle, and therefore can be dried after washing in a drying machine without detracting from the effectiveness of the garment treatment.

Various embodiments of the washing machine packet can also include fabric softener, such as mixed in with the detergent and/or the garment treatment, or in a subcapsule or separate chamber. Various embodiments of the washing machine packet can also include an antistatic substance, such as mixed in with the detergent and/or other substances, or in a subcapsule or separate chamber.

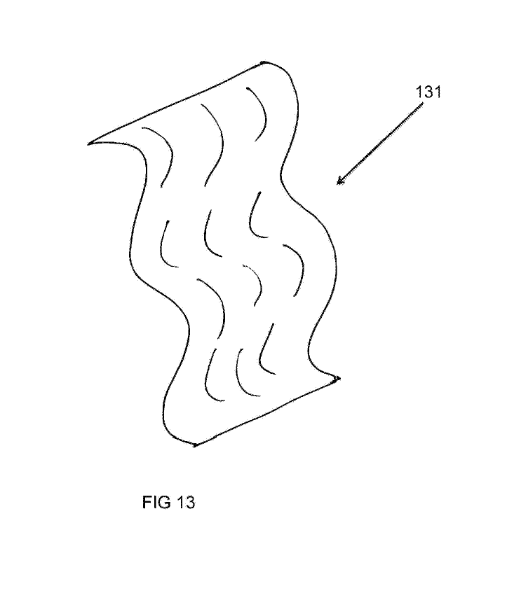

Another embodiment of the present invention is a washing machine sheet 131, as illustrated in FIG. 13. Washing machine sheets according to the present invention can be fibrous sheets, such as a synthetic or natural felt material. In some embodiments, washing machine sheets can be infused with washing detergent, fabric softener, garment treatments, or any combination thereof. Various embodiments of washing machine sheets can be introduced into a wash cycle with clothing, either at the beginning of the cycle, or in some embodiments, after the wash cycle and at the start of or during the rinse cycle. In contact with the wash water, the water can dissolve the infused detergent, garment treatment, fabric softener, or any combination thereof from the washing machine sheet, allowing the dissolved substance to have its intended effect in the wash and leaving the fibrous sheet to be inert in the laundry load for the rest of the cycle. After the laundry load is complete, the used washing machine sheet can be discarded. Some washing machine sheets can be single use, and some can be multiple use, allowing introduction into multiple loads of laundry before becoming exhausted and discardable.

Some embodiments of washing machine sheets can be washing machine/dryer sheets. Washing machine/dryer sheets can be left in the laundry load after the wash and rinse cycles are complete. Washing machine/dryer sheets can have further activity when introduced into the dry cycle. For example, in addition to a water soluble activity, a washing machine/dryer sheet can have a thermally-triggered activity as well. Such embodiments can be used in a cold water wash cycle, for example to release a detergent, fabric softener, garment treatment, and/or antistatic substance, and then introduced into the dryer with the laundry load, whereupon, during a heated dry cycle, the sheet can release a further substance such as a antistatic, fabric softener, and/or garment treatment substance.

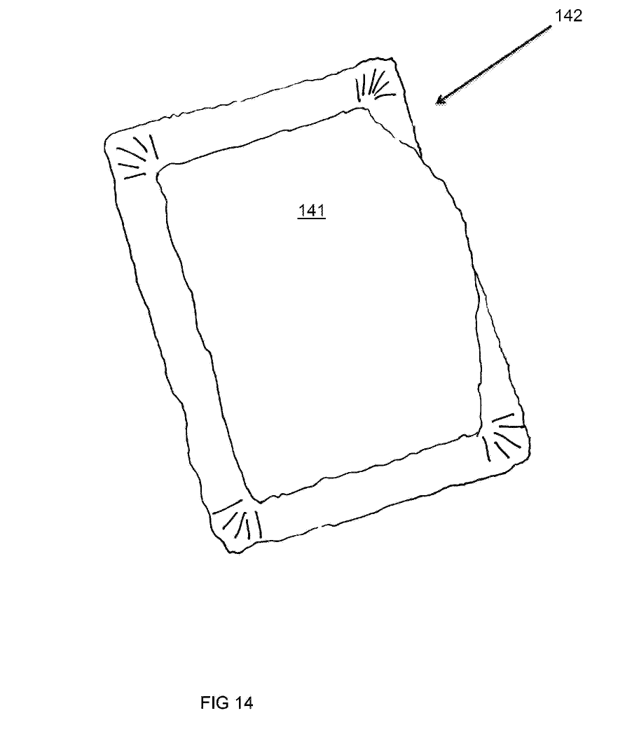

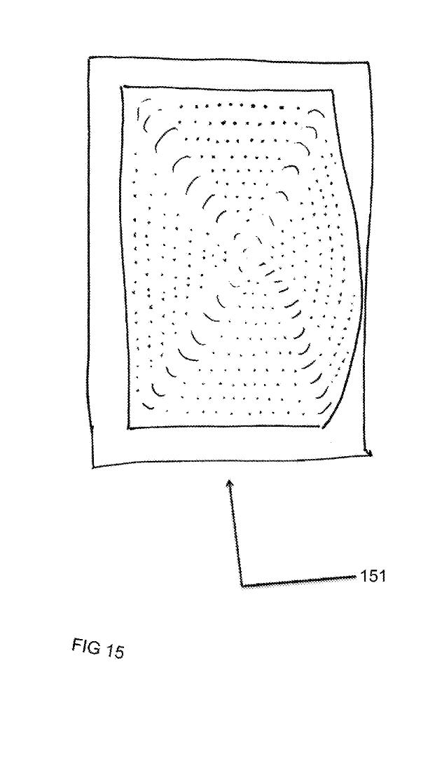

Another embodiment of the present invention is a water permeable laundry pouch containing a powder. For example, a fibrous textile pouch, a mesh pouch, or a perforated pouch. FIG. 14 illustrates fibrous laundry pouch 141. Fibrous laundry pouch 141 is formed from a fibrous material 142. FIG. 15 illustrates perforated laundry pouch 151. In various embodiments, the powder within the pouch can be washing detergent, soap, fabric softener, antistatic substance, garment treatment, or any combination thereof. In various embodiments, the pouch itself can be infused with various laundry substances, such as detergent, soap, fabric softener, antistatic substance, or any combination thereof. Some embodiments of the inventive laundry pouches can be added to the wash cycle, whereupon they can be configured to release their clothes washing substance such as detergent, and/or any other substances having activity during the wash cycle, including a garment treatment. In some embodiments, after the wash cycle, the empty pouch can then be transferred with the wet laundry to the dryer for the drying cycle. In some embodiments, the empty pouch can have antistatic or garment treatment activity in the dryer.

Embodiments of laundry pouches according to the present invention can use laundry detergents and garment treatments that are compatible—in other words, garment treatments that are not readily susceptible to being “washed off” by the detergent, such as garment treatments that are not dissolved, surfacted, or otherwise readily reactive with the detergents or soaps used in the laundry pouch, but rather may be, for example, only reactive with human perspiration or other activation mechanism associated with the wear of the garment on the human skin.

A further embodiment of the present invention is a solid dryer stick—a material dispenser configured to be affixed to the inner chamber of a dryer, such as on the interior of the dryer door. Solid dryer sticks can be configured with various affixation elements to fix them to the interior of the dryer. Some embodiments may use an adhesive, such as a heat resistant adhesive, for example disposed on adhesive pads. In various embodiments, the adhesive can be releasable or permanent.

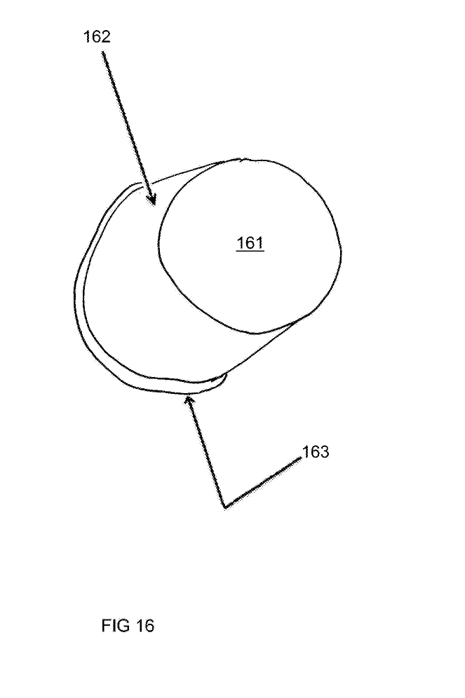

FIG. 16 illustrates one embodiment, solid dryer stick 161. In such embodiments, the solid dryer stick can release a substance, such as a garment treatment substance, or an antistatic substance, or a fabric softener substance, or any combination thereof, onto any clothes being dried during the dry cycle. Solid dryer stick 161 has an active substance element 162, and a base element 163. Active substance element 162 can be a soft solid, for example comprised of an inert delivery substance infused with an active ingredient, such as a garment treatment or other laundry substance as disclosed herein. Base element 163 can secure the active substance element 162 to the dryer, through various attachment elements (not shown). As illustrated, solid dryer stick 161 is roughly the shape of a truncated cylinder. Other embodiments of solid dryer sticks may be in other shapes. Embodiments of solid dryer sticks can have active substance element with a volume of between 1 cubic centimeter and 100 cubic centimeters, for example 10 cubic centimeters. In various embodiments, the base element can have a substantially planar mounting surface configured to interface with the interior surface of the dryer. In various embodiments, the mounting surface can have a surface area of between 1 and 200 square centimeters, for example 17 square centimeters.

In various embodiments, the active substance element 162 can release the active laundry substance(s) in response to the dryer heat, or in response to the contact of the clothes against the solid dryer stick during the dry cycle, or a combination thereof. Embodiments of solid dryer sticks can release active ingredients in the form of vaporized material that can infuse the garments being dried, for example, or can transmit their active ingredients to the clothes being dried through rubbing some of their material off onto the clothes, which can then be uniformly dispersed through the fibers of the clothing by virtue of the heat and/or mechanical tumbling of the clothes. In some embodiments of methods using solid dryer sticks, the user can turn the clothes to be treated inside out before placing in the dryer, for example to allow any garment treatment active ingredient to become deposited on the inside of the garment for enhanced transferability to the wearer.

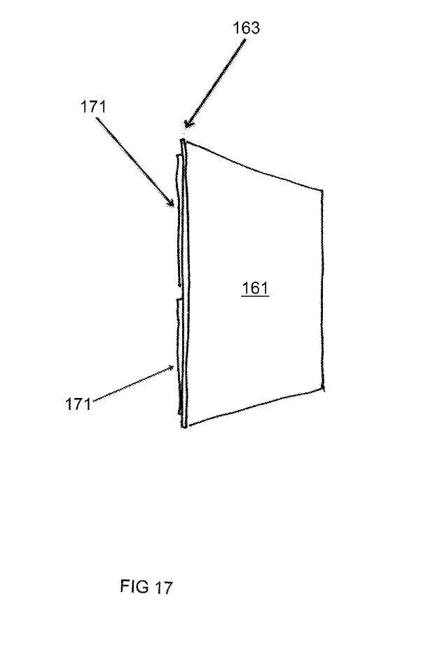

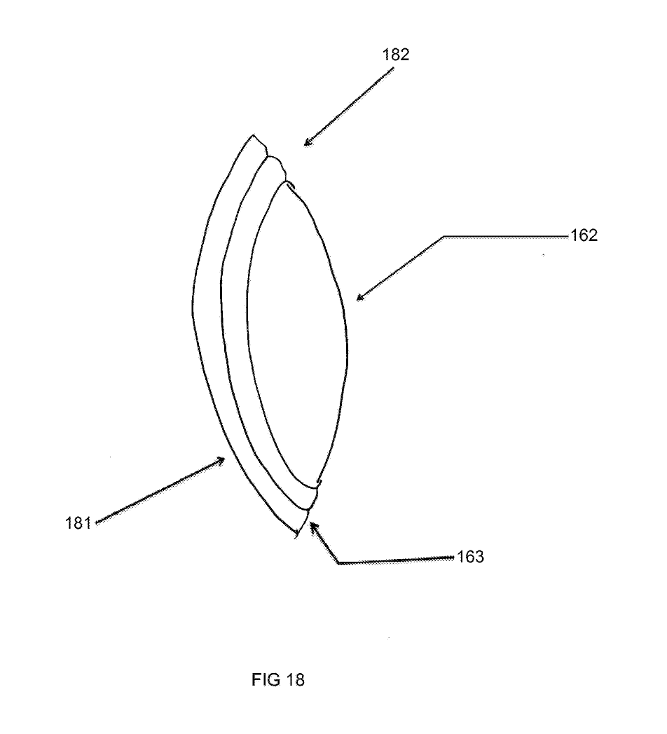

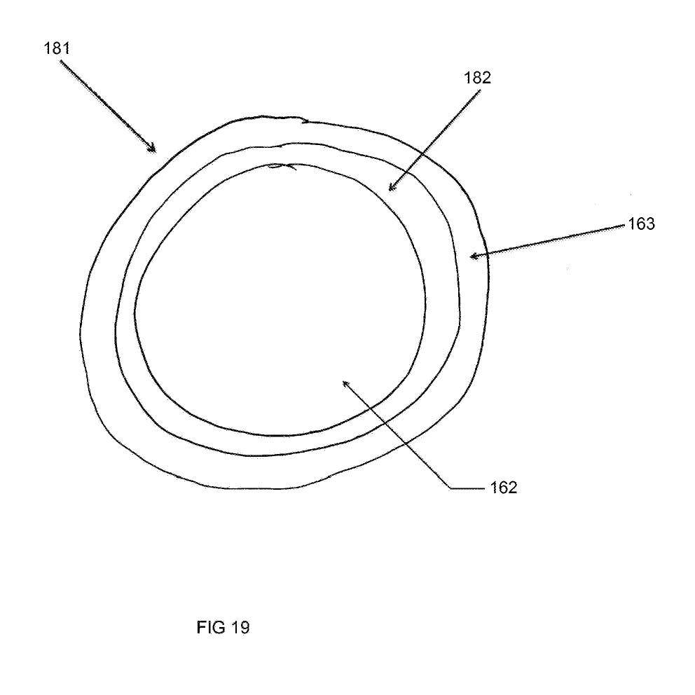

FIG. 17 illustrates a side view of solid dryer stick 161. FIG. 17 illustrates base element 163, and adhesive pads 171. Adhesive pads 171 can be used to affix solid dryer stick 161 to the interior of a dryer, for example to the interior of the dryer door. FIG. 18 illustrates an oblique-front view of another embodiment of a solid dryer stick, solid dryer stick 181. Solid dryer stick 181 has an active substance element 162, and a base element 163. Solid dryer stick 181 is formed in a dome shape for consistent and smooth distribution of the active substances contained in active substance element 162 onto the clothes being dried. Solid dryer stick 181 has two sections of active substance element; active substance element 162 and second active substance element 182. This allows solid dryer stick 181 to simultaneously deliver two active substances, such as any two of garment treatment, antistatic substance, and fabric softener, to the clothes being dried. FIG. 19 illustrates a front view of solid dryer stick 181. FIG. 19 illustrates active substance element 162, base element 163, and second active substance element 182.

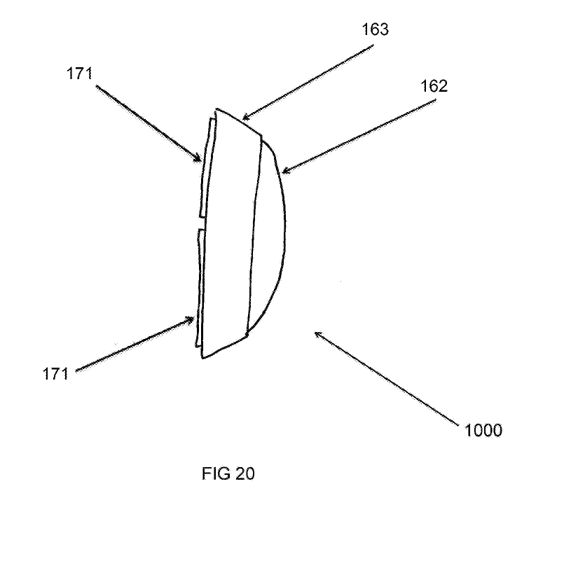

FIG. 20 is a side view of solid dryer stick 1000, similar to solid dryer stick 181 but with one rather than two active substance elements. FIG. 20 shows active substance element 162 and base element 163. FIG. 20 further illustrates adhesive pads 171, configured to affix solid dryer stick 181 to the inside of a clothes dryer. Adhesive pads 171 can use a heat resistant adhesive to withstand the heat within a dryer without releasing and causing solid dryer stick 181 to fall off.

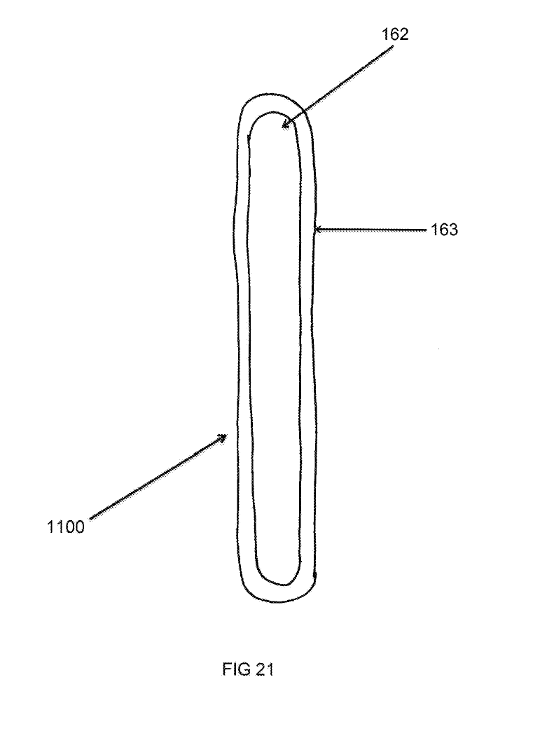

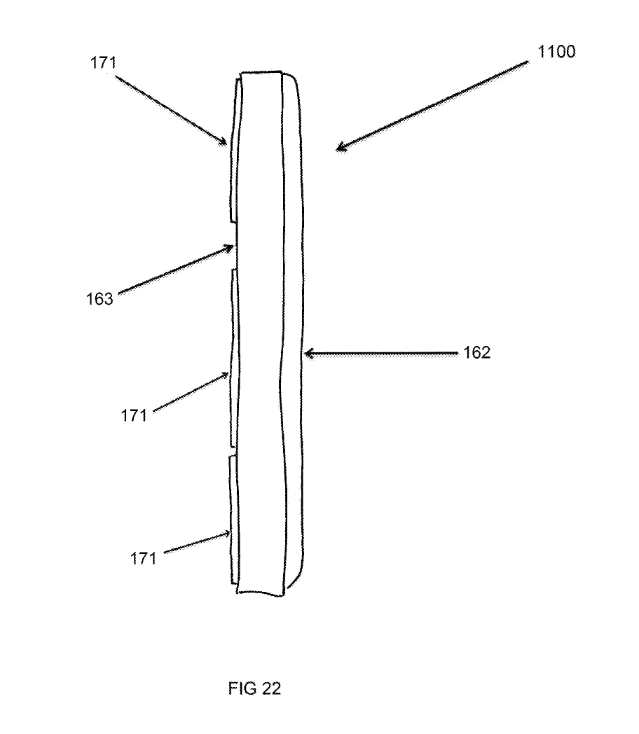

FIG. 21 is a front view of solid dryer stick 1100. Solid dryer stick has an elongate shape and is configured to be affixed to the inside door of a laundry dryer so that its long axis is perpendicular to the direction of the clothes being tumbled, enabling solid dryer stick 1100 to deliver treatment to the entire load of clothes evenly. FIG. 21 illustrates that solid dryer stick 1100 has a base element 163 and an active substance element 162. FIG. 22 illustrates a side view of solid dryer stick 1100, including active substance element 162, base element 163, and adhesive pads 171.

Various methods using the disclosed systems form a part of the present invention. For example, in one method for laundering clothes so as to impart a healthful treatment, a user can load a load of conventional, dirty clothing, such as athletic clothing, into a conventional mechanical washing machine. The user can they start a standard wash cycle. Instead of conventional laundry detergent, the user can then add a laundry packet to the wash. The laundry packet can then dissolve in contact with the wash water, releasing detergent to wash the clothes, and also release a garment treatment substance, such as a slimming treatment. After the wash has finished, the user can remove the load of laundry and then air dry them or load them into a mechanical dryer. After the clothes are dried, the user can wear the clothing and experience the healthful effect of wearing the clean, treated clothing.

In another embodiment of a method according the present invention, a user can load a load of dirty laundry to a conventional mechanical washing machine. Then instead of adding conventional laundry detergent, the user can add a laundry pouch such as described herein. The user can select a cold water wash cycle, and the laundry pouch can release the detergent during the wash cycle to clean the clothing. The laundry pouch can further release a garment treatment during the wash cycle, which treatment can infuse the clothes, by which treatment can be resistant to being washed off by the detergent. At the completion of the wash and rinse cycles, the user can remove the wet clothing and then load the wet clothing into a conventional dryer, along with the used laundry pouch, which is by then empty of any detergent or other powders. The user can select a warm air dry cycle. During the dry cycle, the laundry pouch can have antistatic and/or fabric softening activity, for example through the release of thermally-reactive substances.

A further method according to the present invention is a method of treating clothing to have a beneficial health effect through drying the clothing in a conventional mechanical clothes dryer, such as a gas or electric residential dryer. The method includes a user affixing a solid dryer stick according to the present invention to the inside door of the dryer. The user then loads a load of clean, wet laundry to be treated into the dryer. The user then starts the dryer on a normal cycle to dry the clothes. Upon the conclusion of the drying cycle, the user then removes the clothes and wears them, and experiences the healthful effects of the delivered garment treatment

All of the disclosed laundry treatment systems, components, and methods can be used to treat bed linens, for example to impart a garment treatment having a calming, soothing, or other sleep or rest-inducing or enhancing activity, such as aromatherapy or moisturizers, for example for use where the air is very dry, alone or in conjunction with a humidifier.

Another embodiment of the present invention is a dry cleaning solution that simultaneously cleans the garment and deposits a garment treatment thereupon. A further embodiment of the present inventive garment treatment delivery systems is a washing machine liquid that contains a garment treatment and any one or more of the following: detergent, antistatic substance, fabric softener. A further embodiment is a washing machine powder that contains a garment treatment and any one or more of the following: detergent, antistatic substance, fabric softener.

Some embodiments of the present inventions can be used to treat specially adapted cosmetocompression garments. As used herein, “cosmetocompression” refers to garments that combine strategically-placed regions of various compression textiles with cosmetotextile or dermotextiles in a novel way to provide more and different benefits than are possible using existing technologies. Embodiments of the present invention can also be used to treat standard compression garments to create cosmetocompression effects.

In various embodiments of the present garment treatment systems, garment treatments may be timed-release treatments. Other embodiments may use garment treatments configured to release their active ingredient to the wearer substantially immediately upon donning or wearing the garment. Some embodiments of the present invention may employ microcapsule garment treatments. Other embodiments may employ microparticle or nanoparticle garment treatments not involving microcapsules.

Microcapsule and other garment treatments delivered according to the present invention, such as microcapsule treatments, may offer a “dry” hand even immediately after treatment. In some embodiments, microcapsule treatments can be suspended in a disclosed delivery substance, such as a solid or a liquid, that can dissipate or evaporate after treatment, leaving the microcapsules behind. The active ingredient of the garment treatments can be contained within the microcapsule, and become released only in response to mechanical, thermal, chemical, or moisture stimulus from the skin of the wearer, and only directly onto the skin of the wearer. This can result in the ability to wear the treated garments under other clothes or as an outer layer without any perceptible “rub off” or “soak through” of the garment treatment onto other clothing or environmental objects.

In various embodiments of the present garment treatment systems and methods, the release or activity of the active element of the treatment preparation may be triggered during wear, such as by circumstances incident to wear. For example, in the case of an garments treated with a treatment using microcapsules containing a health preparation, the health preparation may be released as the microcapsules are broken. Microcapsules may be broken due to friction, such as friction against the wearer's skin, pressure, temperature, such as the body heat of the wearer, or other circumstances as known in the microcapsule arts. Examples of the microparticle, nanoparticle, or microcapsule embodiments of the garment treatments delivered according to the present invention may release the active health preparation to the wearer based on binary activation, such as by the introduction of a second preparation. Other embodiments of the present garment treatment systems and methods may release active ingredients in response to temperature, skin pH, such as triggered by the sweat or skin oils of the wearer, by moisture, such as ambient moisture or the moisture associated with the perspiration of the wearer, or another mechanism as is known in the microcapsule, microparticle, or nanoparticle arts.

In various embodiments of the present garment treatment systems and methods, the garment treatment may persist at effective levels in a treated garment for various durations, for example for between one and 100 wearing and wash cycles, such as for ten wearing and wash cycles, before requiring retreatment according to the inventive systems and methods. Other embodiments of the present inventions may provide permanent or semi-permanent treatment effects.

In various embodiments, garment treatments delivered according to the present inventions may be cosmetic in nature, such as self-tanning preparations, essential oils, moisturizers, glycolic acid, retinol, antioxidants, alpha hydroxyl acids, bleaches, lighteners, or other cosmetic skin treatments as are known in the dermatological arts. In various embodiments of the present garment treatment systems and methods, garment treatments may include body slimming, toning, firming, or shaping treatments, for example calorie burning treatments, or metabolic enhancers. In various embodiments of the present garment treatment systems and methods, garment treatments may include wellness treatments such as aromatherapies.

In various embodiments, the garment treatments delivered according to the present invention may have a pharmacological activity, such as provided by over the counter preparations and prescription pharmaceutical treatments. In various embodiments, the treatments may include topical or transdermal skin treatments, corticosteroids, rubefacients, anti-irritants, antihistamines, anti-allergy preparations, anti-inflammatories, anesthetics, and analgesics. Some embodiments of the present invention can treat garments with pharmaceutical products to treat various skin conditions, for example to treat acne. For example, some embodiments can treat garments with benzoyl peroxide or salicylic acid. Some embodiments can treat garments with preparations for the treatment of acne scarring or other skin scarring such as dermabrasion or lighteners.

Various garment treatments delivered according to embodiments of the present invention may relieve muscle aches and muscle soreness, for example from overexertion, strains, or post exercise or labor soreness. For example, some garment treatments can provide muscle-soothing rubefacients such as menthol or another topical analgesic. In some embodiments of the present garment treatment systems and methods, the rate of release of the active ingredient of the garment treatment can be a function of the activity level of the wearer, such as by using microcapsules that break open in response to friction or pressure from the wearer's body.

Some garment treatments delivered according to the present invention can have a performance enhancing activity, such as an energy stimulant, metabolic stimulant, or a nervous or circulatory stimulant, for example to boost performance during a sporting event or competition. Exemplary garments treated according to the present invention may include base layer core garments such as resistance tees and shorts treated with herbal or synthetic metabolic stimulants, such as a thermogenic formula.

Embodiments of the present inventive garment treatment methods and systems can treat garments constructed of any synthetic fabric capable of being made into a garment, such as nylon, polyester, acrylic, polyolefin, rayon, acetate, or another synthetic fiber fabric. Embodiments can also treat any garment made natural fibers, or a natural/synthetic blend using a natural fiber, such as wool, cotton, linen, flax, silk, jute, hemp, sisal, burlap, or any other natural fiber fabric capable of being made into a garment.

Systems and methods of garment treatment according to the present invention can be used to treat professional wear, daytime wear, evening wear, formal wear, undergarments, athletic garments, sleeping garments, or any other type of clothing. For example, tank tops, camisoles, blouses, Capri pants, tights, shorts, tummy shorts, hosiery, and skorts. Systems and methods of garment treatment according to the present invention can be used to treat garments to be worn alone or worn under other, conventional clothing.

Embodiments of the present invention may include garment treatment systems and methods for use in hospital laundries, for example, to prepare garments for post-operative wear. For example, embodiments of the present invention can deliver anti-itching garment treatment to the patient to discourage scratching, speed healing, reduce infection from scratching, and increase patient comfort. Some embodiments of the present garment treatment methods and systems can be used in home or chronic care situations, for example to deliver garment treatments adapted to treat chronic medical conditions, such as diabetes, edema, vascular disease, varicose veins, or another health problem.

1. A health garment system, comprising:
a garment for wearing in contact with the body of a wearer;
the garment comprising a plurality of zones comprising a stretching textile material, each zone connected to at least one other zone of the garment, each zone ergonomically placed to apply compression against the wearer to provide a health benefit;
at least one zone of the garment applying a compression force that is different from a compression force of another zone of the garment;
a first zone of the plurality of zones compressing in a first direction and a second zone of the plurality of zones compressing in a second direction; and
a garment treatment that includes a garment preparation for enhancing the health benefit upon contact of the preparation with the body of the wearer,
wherein at least one zone of the garment is configured to receive the garment treatment that includes the garment preparation.

2. The health garment system of claim 1, wherein the health benefit comprises slimming.

3. The health garment system of claim 1, wherein the health benefit comprises reduction of cellulite.

4. The health garment system of claim 1, wherein the health benefit comprises improving muscle tone.

5. The health garment system of claim 1, wherein the health benefit comprises improvement of a skin condition.

6. The health garment system of claim 1, wherein the health benefit comprises improved energy.

7. The health garment system of claim 1, wherein the health benefit comprises relieving muscle pain.

8. The health garment system of claim 1, wherein the garment preparation comprises a microparticle or a nanoparticle.

9. The health garment system of claim 1, wherein the garment preparation is configured to be applied by the wearer.

10. The health garment system of claim 1, wherein the garment preparation includes one of: a liquid, a cream or a powder.

11. The health garment system of claim 1, wherein the garment preparation is configured to be applied via one of: a liquid spray, an atomizer, a nebulizer, an aerosol, steaming, soaking or infusing.

12. The health garment system of claim 1, wherein the garment preparation comprises any one of: a topical treatment for skin, transdermal skin treatment, a corticosteroid, a rubefacient, an anti-irritant, an antihistamine, an anti-allergy treatment, an anti-inflammatory treatment, an anesthetic or an analgesic.

13. The health garment system of claim 1, where in the garment preparation comprises a microcapsule.

14. The health garment system of claim 1, wherein the garment preparation is released in response to mechanical, thermal, or chemical stimulus.

15. The health garment system of claim 1, further comprising a third zone of the plurality of zones, the third zone comprising a material applying a non-directional compression force against the body of the wearer.

16. A health method, the method comprising:
providing a garment for wear in contact with the body of a wearer, the garment comprising a plurality of zones ergonomically disposed on the garment to provide a health benefit, each zone connected to at least one other zone, a first zone of the plurality of zones exerting a first compressive force on the body of the wearer when the garment is worn, the first compressive force different from a second compressive force exerted by a second zone, the first compressive force oriented along a first force direction, the first force direction different from a second force direction associated with the second compressive force; and,
applying a garment preparation for treatment of the garment, the garment preparation enhancing the health benefit upon contact of the garment preparation with the body of the wearer during wear of the garment.

17. The method of claim 16, wherein the garment preparation is configured to enhance a body slimming health benefit.

18. The method of claim 16, wherein the garment preparation is configured to enhance a visible cellulite reduction health benefit.

19. The method of claim 16, wherein the garment preparation is configured to enhance a muscle tone improvement health benefit.

20. The method of claim 16, wherein the garment preparation is configured to enhance a skin condition health benefit.

21. The method of claim 16, wherein the garment preparation is configured to enhance an energy increase health benefit.

22. The method of claim 16, wherein the garment preparation is configured to enhance a visible cellulite reduction health benefit.

23. The method of claim 16, wherein the garment preparation comprises microparticles.

24. The method of claim 16, wherein the garment preparation comprises one of: a liquid, a cream or a powder.

25. The method of claim 16, wherein the garment preparation for treatment of the garment is applied via one of: a liquid spray, an atomizer, a nebulizer, an aerosol, steaming, soaking or infusing.

26. The method of claim 16, wherein the garment preparation comprises microcapsules.

27. The method of claim 16, wherein the garment preparation comprises microcapsules, the microcapsules adapted to release their contents in response to a mechanical, thermal, or chemical stimulus.

28. The method of claim 16, wherein the garment preparation comprises any one of: a topical treatment for skin, transdermal skin treatment, a corticosteroid, a rubefacient, an anti-irritant. an antihistamine, an anti-allergy treatment, an anti-inflammatory treatment, an anesthetic or an analgesic.

29. The method of claim 16, wherein the garment preparation is adapted to be applied to the garment by the wearer.

30. The method of claim 16, wherein the plurality of zones further comprises a third zone of the plurality of zones, the third zone applying a non-directional compressive force against the wearer during wear to enhance the health benefit.

31. A health laundry method comprising:
introducing a garment into a mechanical laundry machine, the garment configured to impart a health benefit to a wearer by exerting at least one compressive force to the wearer during wear of the garment, the at least one compressive force exerted by a plurality of garment zones, the plurality of garment zones ergonomically disposed on the garment;
introducing a garment treatment into the mechanical laundry machine, the garment treatment adapted to enhance the health benefit to a wearer of the garment during wear,
initiating a cycle of the mechanical laundry machine; and
after the completion of the cycle, wearing the garment.

32. The method of claim 31, wherein the mechanical laundry machine is a clothes washer.

33. The method of claim 31, wherein the mechanical laundry machine is a clothes dryer.

34-44. (canceled)
